(19) United States
(12) Patent Application Publication
(10) Pub. No.: US 2012/0314528 A1
(43) Pub. Date: Dec. 13, 2012

(54) DEVICE, FLUIDIC MODULE AND METHOD FOR PRODUCING A DILUTION SERIES

(75) Inventors: Guenter ROTH, Freiburg (DE); Oliver STROHMEIER, Freiburg (DE); Roland ZENGERLE, Waldkirch (DE)

(73) Assignee: Albert-Ludwigs-Universitaet Freiburg, Freiburg (DE)

(21) Appl. No.: 13/469,108

(22) Filed: May 11, 2012

(30) Foreign Application Priority Data
Jun. 8, 2011 (DE) 102011077199.9

(51) Int. Cl. B01F 15/04

(52) U.S. Cl. 366/160.5

(57) ABSTRACT

A device for producing a dilution series from a solution to be diluted, which contains a substance to be diluted, and a dilution solution, includes a body of rotation, a drive configured to subject the body of rotation to rotations having different rotation protocols, and a controller configured to control the drive so as to subject the body of rotation to the different rotational frequencies. A first mixing chamber and a second mixing chamber are connected via a fluidic connection which enables producing, in the first mixing chamber, a first mixture having a first dilution ratio, transferring a partial volume of the first mixture into the second mixing chamber, and there producing a second mixture having a second dilution ratio.

### CROSS-REFERENCE TO RELATED APPLICATIONS

This application claims priority from German Patent Application No. 102011077199.9, which was filed on Jun. 8, 2011, and is incorporated herein in its entirety by reference.

The present invention relates to devices, fluidic modules and methods for producing a dilution series and, in particular, to devices and methods for producing a dilution series on a centrifugal-microfluidic platform.

### BACKGROUND OF THE INVENTION

Producing dilution series is a routine task in any biological, chemical or medical laboratory all over the world. Manually diluting reagents or samples by means of a pipette may be done for a multitude of applications and is therefore an integral part of daily laboratory work. Depending on the task set, typically 3 to 10 dilutions having dilution factors of between 2 and 20 are produced. Should a specific dilution series be used very often, automation by means of a pipetting robot may be effected. Possible examples for using dilution series include:
diluting nucleic acids in connection with a (quantitative) polymerase chain reaction (PCR) for producing a calibration standard with a known amount of nucleic acids or for determining the concentration of an unknown nucleic-acid sample.
diluting antibodies for immunodiagnostic applications for setting an operating or detection point of an ELISA (enzyme-linked immunosorbent assay) or competitive immunoassay as well as producing a dilution series of a known sample for calibrating the assay itself.
diluting inhibitors and determining the concentration-induced effect on the enzyme activity, for example for determining the IC 50 value.
determining dose-response relationships for determining minimum doses, and studying the general dependence between the dose and the effect to be studied.
preparing calibration dilutions of any kind, for example of the optical density of suspensions of bacteria, of fluorescent dyes, of enzymes, of samples in a buffer as well as of inhibitors and activators.

For example, one specific application is typical enzyme kinetics measurement. To this end, a dilution series of a substrate of an enzyme in used in most cases, and the amount of a product produced within a predefined time period and/or the conversion rate of the enzyme within the product per time unit is measured. The dilution series in most cases includes 2 to 4 orders of magnitude of concentrations of the substrate. The amount of enzyme remains constant in this context. Dilution series of similar types are produced in inhibition studies, the amount of enzyme and the amount of substrate being kept constant. It is only the inhibitor that is diluted.

A further specific application comprises using a dilution series for determining a number of bacteria. To this end, the bacteria are diluted, in most cases in a decade logarithmic dilution series, and a small volume of each dilution is plated. The dilution found to be “countable” (several to less than one thousand bacterial colonies) is detected, and the total number of bacteria from the sample is calculated from the values obtained and while taking into account the dilution factor.

A further specific utilization of a dilution series comprises determination of a DNA concentration and/or utilization for calibrating a PCR thermocycler. A dilution series is prepared from a solution containing DNA. Said dilution series is subsequently mixed with a PCR mix, and the corresponding enzymatic reaction is performed. The dilution series of the DNA are measured, and subsequently, the initial concentration of the DNA may be determined from the characteristic slope of the curves obtained. Since the initial concentration is unknown in most cases, a dilution series is produced to determine the point at which no more signal can be produced. Said dilution will then correspond to the concentration of DNA which in purely statistical terms contains no more DNA strand. Thus, the concentration of the DNA may be determined from this “non-occurrence” of the signal. By contrast, a sample having a known DNA may be used for validating the PCR system. For this purpose, too, one produces a dilution series so as to show that the points in time of the characteristic signal rise of the PCR linearly correlate with the concentration of the DNA.

Automated production of dilution series may be effected by means of a pipetting robot, which is, however, not economic due to the cost involved specifically for applications with low and medium throughputs. Moreover, when producing dilution series, one is to take a lot of care to avoid contamination and cross-contamination. This is sometimes very difficult to achieve with automated solutions, when the parts of the pipetting robot that are contaminated may be cleaned, or this signifies a high conversion rate of materials used, such as disposable pipetting tips, while involving a large amount of technical expenditure for the mechanical systems for receiving said tips, checking their correct seats and ejecting them after the dispensing process.

Consequently, dilution series, in particular indirect dilution series, are typically produced by means of manual pipetting. This includes several repetitions of the following steps:
1. Adding a defined volume of the solution A (solution to be diluted) to a precharged defined volume of the solution B (dilution solution)
2. Thorough and complete mixing and homogenizing of the dilution, and, if need be, centrifuging off in the event of foaming;
3. Removing a defined volume of the dilution AB and transferring it into a defined volume of the solution B; and
4. Cyclically repeating steps 2 and 3 until a corresponding dilution series has been produced.

What is particularly problematic here is the exponential propagation of pipetting errors. For example, a pipette that has been set wrongly once or insufficient mixing at the beginning of the dilution series will have repercussions on all of the concentrations derived therefrom. This error occurs once and linearly propagates throughout the dilution series. Should the pipetting step for precharging the solution B or for removing and transferring the dilution AB be faulty, this error will propagate exponentially.

In addition, manual handling of minute volumes of liquid with corresponding precision represents a corresponding challenge. For example, it is useful—in order to prepare a dilution having a dilution factor of 10 and a total volume of 10 μl—to mix 1 μl of a solution A with 9 μl of a solution B. For automation in the volume regime described, specific dispensing systems may be used to ensure the level of precision needed.

In conventional technology, various microfluidic systems for automatic production of discrete dilutions or concentration gradients have been described. Fundamentally, a distinction is made here between centrifugal and pressure-operated microfluidic systems by means of the type of actuation of liquid. While centrifugal systems can switch and move liquids passively by means of targeted rotation and of the centrifugal forces resulting therefrom, liquids in pressure-operated systems are moved by means of an external pressure source, such as a syringe pump or an air-pressure source such as described by D. Mark et al., Chem. Soc. Rev., 2010, 39:1153-1182. The advantage of centrifugally actuated systems is basically the possibility of being able to operate with minute volumes and in a manner that is almost free from any dead volume. On the other hand, maximum volumes are limited to several ml. Pressure-operated systems may basically process larger volumes (up to volumes of m³ in the production of foodstuffs such as multivitamin juices, for example). For large-volume dilutions (>50 μl), manual pipetting errors tend to be negligible.

C.-Y. Chen et al., Proc. MicroTas, 2010, pp. 752-754, describe a PDMS (polydimethylsiloxane) chip comprising five liquid inlets, one outlet, and magnetically controlled valves. Depending on the valve position, dilution stages having ratios of 1:10 may thus be produced over 5 orders of magnitude. As an example of use, tetraethylammonium (TEA) is diluted in a buffer, and the effect on the ion channels of cells is observed. The system is very complex in terms of structure and exhibits very large dead volumes (for filling the tubes).

J. Koehler et al., Assay Drug Develop., 2002, pp. 91-96, describe pressure-operated fluidics for automatically producing dilutions. As an example of use, various substrate liquids (chemical compounds that are converted in a reaction catalyzed by an enzyme) are diluted for enzyme kinetics and dose-response measurements. The system is designed such that the resulting fluorescent signals may be read out in a standard microwell plate reader. The dead volumes are very large, the dilution stages may be programmed, and the dilutions cannot simply be removed. Introduction of air bubbles or the changes of fluidic resistances lead(s) to uncontrollable misadjusting of the flow rates and, in this manner, create(s) errors in the dilutions.

In addition, various pressure-operated fluidic systems for producing concentration gradients are described by Noo Li Jeon et al., Langmuir, 2000, 16:8311-8316, and Kyle Champbell et al., Lab Chip, 2007, 7:264-272.

Inertia-induced mixing of liquids in a mixing chamber by varying the rotational frequency has been described by M. Grumann et al., Lab Chip, 2005, 5:560-565.

US 2008/0193336 A1 discloses a centrifugal-microfluidic system for producing dilutions. Liquids may be mixed in a central mixing chamber. Here, the dilution factor Z and the volumes created are determined by several channels that transfer, at a defined radial height, liquid from the fill-in chambers to the mixing chamber. Alternatively, several fill-in chambers may be used, the contents of which are serially transferred into the mixing chamber in each case following opening of a valve. The mixture produced may subsequently continue to be passed on into final chambers. In order to open or close the corresponding fluidic paths, the cartridge has wax valves integrated therein which may be actively molten via an external laser. The volumes and the dilutions are predefined by the microfluidic design of the cartridge and cannot be modified later on.

US 2011/0085950 A1 discloses a microfluidic system comprising a spindle motor, via which a carrier may be driven. Cartridges having fluidic structures (46) formed therein may be inserted into the carrier.

U.S. Pat. No. 6,004,515 and U.S. Pat. No. 5,869,004 are directed at methods and devices for producing dilutions, wherein dilutions are produced by means of a main channel, particularly while using an electro-osmotic flow.

U.S. Pat. No. 6,632,655 B1 describes techniques wherein arrays of flowable or solid sets of particles are used in microfluidic systems to perform assays and to modify a hydrodynamic flow.

### SUMMARY

According to an embodiment, a device for producing a dilution series from a solution to be diluted, which contains a substance to be diluted, and a dilution solution, may have: a body of rotation including fluidic structures, a drive configured to subject the body of rotation to rotations of different rotation protocols, and a controller configured to control the drive so as to pass through the rotation protocols, which fluidic structures may have: a first mixing chamber including at least one fluid outlet, a second mixing chamber including at least one fluid inlet, a fluidic connection between the fluid outlet of the first mixing chamber and the fluid inlet of the second mixing chamber, the fluidic connection between the first mixing chamber and the second mixing chamber being configured such that, when passing through a first rotation protocol, a defined volume of the solution to be diluted and a defined volume of the dilution solution are mixed in the first mixing chamber so as to produce a first mixture having a first dilution ratio, no portion of the first mixture getting into the second mixing chamber, and the fluidic connection between the first mixing chamber and the second mixing chamber being configured such that, when passing through a second rotation protocol, a defined partial volume of the first mixture is transported from the first mixing chamber through the fluidic connection into the second mixing chamber which has a defined volume of the dilution solution located therein, and such that a defined volume of the first mixture remains in the first mixing chamber, the controller being configured to control the drive to pass through the first and second rotation protocols and to pass through a third rotation protocol after having passed through the first rotation protocol and the second rotation protocol, so as to mix, in the second mixing chamber, the defined partial volume of the first mixture with the defined volume of the dilution solution to produce a second mixture having a second dilution ratio.

Another embodiment may have a fluidic module for a device for producing a dilution series from a solution to be diluted, which includes a substance to be diluted, and a dilution solution, which device may have: a body of rotation including fluidic structures, a drive configured to subject the body of rotation to rotations of different rotation protocols, and a controller configured to control the drive so as to pass through the rotation protocols, which fluidic structures may have: a first mixing chamber including at least one fluid outlet, a second mixing chamber including at least one fluid inlet, a fluidic connection between the fluid outlet of the first mixing chamber and the fluid inlet of the second mixing chamber, the fluidic connection between the first mixing chamber and the second mixing chamber being configured such that, when passing through a first rotation protocol, a defined volume of the solution to be diluted and a defined volume of the dilution solution are mixed in the first mixing chamber so as to produce a first mixture having a first dilution ratio, no portion of the first mixture getting into the second mixing chamber, and the fluidic connection between the first mixing chamber and the second mixing chamber being configured such that, when passing through a second rotation protocol, a defined partial volume of the first mixture is transported from the first mixing chamber through the fluidic connection into the second mixing chamber which has a defined volume of the dilution solution located therein, and such that a defined volume of the first mixture remains in the first mixing chamber, the controller being configured to control the drive to pass through the first and second rotation protocols and to pass through a third rotation protocol after having passed through the first rotation protocol and the second rotation protocol, so as to mix, in the second mixing chamber, the defined partial volume of the first mixture with the defined volume of the dilution solution to produce a second mixture having a second dilution ratio, which fluidic module forms the body of rotation or forms the body of rotation when inserted into a carrier, which includes the fluidic structures which include the first mixing chamber including the at least one fluid outlet, the second mixing chamber including the at least one fluid inlet, and the fluidic connection between the fluid outlet of the first mixing chamber and the fluid inlet of the second mixing chamber.

According to another embodiment, a method of producing a dilution series from a solution to be diluted, which includes a substance to be diluted, and a dilution solution, may have the steps of: introducing a defined volume of the dilution solution into a first mixing chamber and introducing a defined volume of the dilution solution into a second mixing chamber, the first and the second mixing chamber being formed in a body of rotation, and a fluid outlet of the first mixing chamber being connected to a fluid inlet of the second mixing chamber via a fluidic connection; introducing a defined volume of the solution to be diluted into the first mixing chamber; subjecting the body of rotation to a first rotation protocol, so that a first mixture having a first dilution ratio is produced in the first mixing chamber without any portion of the first mixture getting into the second mixing chamber; subjecting the body of rotation to a second rotation protocol, so that a defined partial volume of the first mixture is transported from the first mixing chamber into the second fluid chamber which includes the defined volume of the dilution solution located therein, and so that a defined volume of the first mixture remains in the first mixing chamber; and subjecting the body of rotation to a third rotation protocol so as to mix, in the second mixing chamber, the defined partial volume of the first mixture with the defined volume of the dilution solution to produce a second mixture having a second dilution ratio.

In accordance with embodiments of the invention, a defined volume of a first mixture having a first dilution ratio may be produced in the first mixing chamber, and a defined volume of a second mixture having a second dilution ratio may be produced in the second mixing chamber. Thus, embodiments enable producing a dilution series which comprises two mixtures having different dilution ratios. In embodiments of the invention, n mixing chambers may be provided, n being a natural number≧3, so that a dilution series may be produced with three or more mixtures of different dilution ratios. The mixing chambers are connected via corresponding fluidic connections, the mixtures being produced serially one after the other in that a defined partial volume, respectively, of a mixture is transferred from a preceding mixing chamber into a subsequent mixing chamber via the fluidic connection by performing a corresponding rotation protocol, in which subsequent mixing chamber said defined partial volume is mixed with a defined volume of the dilution solution.

Embodiments of the invention are based on the finding that dilution series may advantageously be produced in an automated manner in that a plurality of mixing chambers are used on a centrifugal platform. In this manner, it is possible, by passing through corresponding rotation protocols, to provide a centrifugal drive for the substance to be diluted, the dilution solution and the mixtures. Thus, by providing corresponding fluidic structures and by varying the rotational frequency applied to the body of rotation, any desired dilution series, such as logarithmic dilution series, can be implemented.

In embodiments of the invention, the fluidic connection comprises a siphon, said siphon comprising a fluid inlet leading into the first mixing chamber at a first radial position, and a fluid outlet leading into the second mixing chamber at a second radial position, the second radial position being located radially outward of the first radial position. Those parts of the first mixing chamber that are located radially outward of the first radial position may specify a defined fluid volume, so that by means of emptying the first mixing chamber via the siphon, a defined liquid volume may remain in the first mixing chamber. In embodiments of the invention which comprise n mixing chambers, a corresponding siphon may be provided between a preceding mixing chamber and a subsequent mixing chamber in each case, the position where the siphon leads into the preceding mixing chamber being located radially inward of that position where the siphon leads into the subsequent mixing chamber.

In embodiments, the mixing chambers extend radially outward from a position where the fluidic connection leads from the preceding mixing chamber into the mixing chamber, so that a preceding mixing chamber is arranged radially further inward in each case than a subsequent mixing chamber. This enables centrifugal transport of liquid between the mixing chambers in a simple manner.

In embodiments of the invention, each mixing chamber may have a dosing chamber associated with it which is connected to the mixing chamber via a fluidic valve. The dosing chambers may form fingers of an aliquoting structure, via which a defined volume of the dilution solution may be introduced into each of the mixing chambers. The dosing chambers may be configured to introduce identical volumes or different volumes of the dilution solution into the various mixing chambers. In embodiments, the dosing chambers of the aliquoting structure are each filled with a defined volume of the dilution solution in that a fourth rotation protocol is passed through, the defined volumes then being introduced into the mixing chambers via the valves in that a fifth rotation protocol is passed through. In embodiments, the valves may be formed by hydrophobic bottlenecks which extend radially outward and through which the dilution solution may pass only from a predetermined rotational speed.

In embodiments of the invention, the fluidic structures for providing a defined volume of the solution to be diluted may comprise a pre-portioning chamber fluidically connected to the first mixing chamber. The pre-portioning chamber may comprise, in embodiments of the invention, a suitable overflow structure, so that the volume of the solution to be diluted which is passed on to the first mixing chamber is independent of a filled-in volume of the solution to be diluted, provided that the amount of the solution to be diluted that is filled in exceeds the defined volume. In embodiments of the invention, the body of rotation and/or the fluidic module may be provided with several pre-portioning chambers, each of which comprises one inlet and different volumes, so that one of several possible dilution series having different dilution ratios may be selected by choosing a corresponding inlet. In embodiments of the invention, the pre-portioning chamber may be provided in an inset that is replaceable, so that different dilution series may be produced by switching between pre-portioning chambers having different defined volumes.

Embodiments of the invention provide a fluidic module which forms the body of rotation or forms the body of rotation when inserted into a carrier. The fluidic module comprises the fluidic structures which enable the dilution series to be produced, as are described herein.

In embodiments of the inventive method, the volume transferred from the first mixing chamber into the second mixing chamber is dependent on an added volume of the solution to be diluted and/or on the defined volume of the dilution solution.

In embodiments of the inventive method, a body of rotation comprising n mixing chambers, one fluid outlet of a preceding mixing chamber being connected to one fluid inlet of a subsequent mixing chamber via a corresponding fluidic connection, respectively, is used. The method may further comprise subjecting the body of rotation to corresponding rotation protocols so as to transport respective partial volumes of an n−1^{th} mixture into an n^{th} mixing chamber, a defined volume of the n−1^{th} mixture remaining in the n−1^{th} mixing chamber so as to produce a dilution series having n mixtures having n different dilution ratios, n being an integer larger than or equal to three. In embodiments, the defined volumes and partial volumes may be such that the n mixtures represent a logarithmic dilution series.

Embodiments of the invention are directed to automated production of dilution series and aim at small volumes (in the μl to ml ranges), so that the corresponding fluidic structures may be designated as microfluidic structures. In particular, embodiments of the invention aim at applications mostly in the analytical field. Embodiments of the present invention may be employed for producing dilution series for any applications desired, for example the fields of application described at the outset.

Embodiments of the invention use centrifugal forces so as to automatically transport, portion and mix liquids. A body of rotation and/or a fluidic module having incorporated cavities and/or (micro)fluidic structures may serve as a platform. The body of rotation and/or the fluidic module may be referred to as a cartridge, which may consist of plastic. While precise and expensive syringe pumps may typically be used for transporting liquids in non-centrifugal microfluidic systems, a standard laboratory centrifuge may be utilized as a drive and as a controller for producing the dilution series in embodiments of the invention. The body of rotation may then be inserted instead of the standard rotor, and the rotation protocols that may be used may be adjusted manually or by using appropriate software.

Within the context of this disclosure, a rotation protocol is understood to mean a rotation of the body of rotation at a rotational frequency or a sequence of rotational frequencies. For example, a rotation protocol may designate a rotation at a specific rotational frequency. A different rotation protocol may include rotations at several different frequencies. Yet another rotation protocol may include stopping the rotation.

What is also advantageous in embodiments of the invention is the possibility of doing without actively controlled valves. An interface with an external periphery is not required. Due to the volumes introduced and the volumes which are predefined (by the fluidic structures) in the body of rotation (the cartridge), the dilutions produced may be unambiguously specified, and the “human” errors occurring during handling as well as the possibility of contamination may be reduced to a minimum.

As compared to systems operated by syringe pumps, embodiments of the invention offer the advantage of clearly reduced dead volumes of the liquids, since tube connections and corresponding fluidic ports for pumping the liquid onto the chip are not required. Thus, embodiments of the invention enable reduced requirement in terms of reagents without employing—as would be the case in syringe pump-operated systems—an immiscible system liquid, which would entail the risk of contamination of the sample and of the dilutions, however. In centrifugal systems, the liquids are controlled by means of inherent inertial forces (centrifugal force). Thus, it is possible to transport even minute amounts of liquid. Consequently, solutions which have only small or no dead volumes whatsoever may be implemented.

Embodiments of the invention enable increased flexibility since they enable the dilution factor to be adjusted, e.g. by switching between inserts having different pre-portioning chambers, as was described above.

### BRIEF DESCRIPTION OF THE DRAWINGS

Embodiments of the present invention will be detailed subsequently referring to the appended drawings. In the drawings, elements which are identical or have identical actions are designated by identical reference numerals, wherein:

FIG. 1 schematically shows top view of the fluidic structures of a body of rotation in accordance with an embodiment of the invention;

FIG. 2 shows a schematic top view of an embodiment of a body of rotation; and

FIGS. 3a to 3h show schematic representations for illustrating production of a dilution series in embodiments of the invention;

FIG. 4 and FIG. 5 show schematic side views of embodiments of inventive devices.

### DETAILED DESCRIPTION OF THE INVENTION

Before embodiments of the invention will be explained in more detail, partly with reference to the drawings, reference shall first of all be made to the following glossary.

### Glossary

The numeric indices n, k, i be natural numbers including 0. Generally, i≦n.
Vₓ be the volume taken from a solution X.
The solution A be the solution to be diluted. It contains the substance to be diluted.
The solution B be the dilution solution. It is used for diluting solution A.
Dilution is to refer to the reduction of a concentration of the substance to be diluted in the solution A in that a volume V_{A} of the solution A and a volume V_{B} of the solution B are mixed with each other.
The dilution AB is to refer to a dilution of the solution A with the solution B.
The dilution AB₁ is to refer to the 1^{st} dilution of the solution A with the solution B.
The dilution AB₀ is to refer to the 0^{th} dilution of the solution A with the solution B and is therefore to be equated with the undiluted solution A.
The dilution ABᵢ be the i^{th} dilution of a dilution series of the solution A with the solution B, and be associated with the dilution factor Zᵢ.
Definitions of volume:
   V_{A} be a volume taken from the solution A.
   V_{Ai} be a volume taken from the solution A to produce the i^{th} solution of a dilution series.
   V_{B} be a volume taken from the solution B.
   V_{Bi} be a volume taken from the solution B to produce the i^{th} solution of a dilution series.
   V_{AB} be a volume, also referred to as a transfer volume V_{AB}, which is taken from an existing dilution AB of the solution A with the solution B and is transferred.
   V_{ABi}, also referred to as a transfer volume V_{ABi}, be a volume taken from an i^{th} dilution of a dilution series to produce the (i+1)^{th} dilution. V_{ABi}≦V_{AB(i-1)}+V_{Bi} shall apply.
   V_{AB0} be a volume corresponding to a 0^{th} dilution of a dilution series of the solution A and is therefore to be equated with the volume V_{A}.
Dilution factor Z: for a dilution AB, the dilution factor is defined as Z=(V_{A}+V_{B} with Z≧1. The concentration c of the substance to be diluted in the dilution AB is reduced to 1/Z as compared to the concentration in the solution A. The produced end volume for the dilution itself is irrelevant.

Numerical Example:
Dilution AB prepared from V_{A}=10 ml of solution A and V_{B}=90 ml of solution B with a dilution factor of Z=10. Concentration of the substance to be diluted in the dilution AB: c=1/10.
An identical dilution, but a different end volume may be produced, for example, with V_{A}=20 ml of solution A and V_{B}=180 ml of solution B or V_{A}=1.1 ml of solution A and V_{B}=9.9 ml of solution B.
Dilution factor Z₀=1 be associated with the undiluted solution A.
Dilution factor Zᵢ: for a dilution ABᵢ, which has been produced from the volume V_{ABk} of the dilution ABₖ having the dilution factor Zₖ by diluting with a volume Bᵢ>0 of the solution B, the following shall apply: Zᵢ=(V_{ABk}+V_{Bi})/V_{ABk}*Zₖ with Zₖ<Zᵢ and k<i.
Dilution series: a dilution series is a number of n dilutions with n>1 and consisting of the individual dilution ABᵢ with i≦n from a solution A and a solution B having different dilution factors Zᵢ. Zᵢ<Zₖ shall apply for i<k within a dilution series.

Numerical Example:
Dilution AB₁: Z₁=₁; 10 ml of solution A diluted with 0 ml of solution B;
Dilution AB₂: Z₂=2; 10 ml of solution A diluted with 10 ml of solution B;
Dilution AB₃: Z₃=2.4; 5 ml of solution A diluted with 7 ml of solution B;
Dilution AB₄: Z₄=2.5; 10 ml of solution A diluted with 15 ml of solution B;
Dilution AB₅: Z₅=8; 20 ml of solution A diluted with 140 ml of solution B; etc.
Direction dilution series: directly diluting from the solution A. Here, all of the dilutions ABᵢ are produced from one volume V_{Ai}, respectively, of the solution A with a corresponding volume V_{Bi}. The dilution factor is calculated by means of Z=(V_{Ai}+V_{Bi})/V_{Ai}.

Numerical Example:
Dilution AB₁: Z₁=10; 10 ml of solution A diluted with 90 ml of solution B;
Dilution AB₂: Z₂=100; 10 ml of solution A diluted with 990 ml of solution B;
Dilution AB₃: Z₃=1000; 10 ml of solution A diluted with 9990 ml of solution B;
Dilution AB₄: Z₄=2000; 10 ml of solution A diluted with 19990 ml of solution B; etc.
Indirect dilution series: serial dilution of a volume V_{ABk} of a previously produced dilution ABₖ with a further volume V_{Bi} of the solution B to produce a dilution ABᵢ. The corresponding dilution factor Zᵢ is calculated in accordance with Zᵢ=(V_{ABk}+V_{Bi})/V_{ABk}*Zₖ with Zᵢ>Zₖ and i>k.

Numerical Example:
Dilution AB₁: Z₁=₁₀; 10 ml of solution A diluted with 90 ml of solution B;
Dilution AB₂: Z₂=100; 10 ml of solution AB₁ diluted with 90 ml of solution B (thus Z₂=10*(10+90)/10);
Dilution AB₃: Z₃=1000; 10 ml of solution AB₂ diluted with 90 ml of solution B (thus Z₃=100*(10+90)/10);
Dilution AB₄: Z₄=2000; 10 ml of solution AB₃ diluted with 190 ml of solution B (thus Z₄=100*(10+190)/10), however there is also the alternative, e.g., to produce the dilution AB₄ from the solution AB₂. 1 ml of solution AB₂ diluted with 199 ml of solution B (thus Z₄=10*(1+199)/1); etc.
Logarithmic dilution series: in most cases an indirect dilution series wherein each dilution has been produced from the preceding one. In most cases, the respectively subsequent dilution ABᵢ is produced from constant volumes V_{Bi}=V_{B1} of the solution B and from constant transfer volumes V_{AB(i-1)}. This results in a dilution factor of Zᵢ=((V_{AB(i-1)}+V_{Bi})V_{AB(i-1)})̂i.

Numerical Example:
Dilution AB₁: Z₁=₁₀; 10 ml of solution A diluted with 90 ml of solution B;
Dilution AB₂: Z₂=₁₀₀; 10 ml of solution AB₁ diluted with 90 ml of solution B;
Dilution AB₃: Z₃=1,000; 10 ml of solution AB₂ diluted with 90 ml of solution B;
Dilution AB₄: Z₄=10,000; 10 ml of solution AB₃ diluted with 90 ml of solution B; etc.
IC 50 value: concentration of an inhibitor wherein an inhibition is observed which reduces the enzyme activity to 50% of the maximum enzyme activity.
LD50 value: lethal dose of a poison at which 50% of the living beings studied die.
DNA: deoxyribonucleic acid.
RNA: ribonucleic acid.
Enzyme: biocatalyst, in most cases based on protein.
PCR: polymerase chain reaction, an enzymatic system for exponential amplification and for identifying nucleic acids such as DNA or RNA.
Michaelis-Menten constant: a characteristic constant from the field of enzyme kinetics. It is measured in mol per 1 and corresponds precisely to that concentration of the substrate at which the enzyme reaches 50% of its maximum conversion rate. 100% of the maximum conversion rate are only achieved at a theoretically “infinite” amount of substrate. The smaller the Michaelis-Menten constant, the smaller the amounts of substrate that are converted fast and efficiently.
Turnover number: a further characteristic constant from the field of enzyme kinetics. It is a measure of the performance of an enzyme and is measured in s⁻¹. It indicates how much substrate a defined amount of enzyme may convert per time unit. The higher the turnover number, the “faster” the enzyme is working.
Most Probable Number: statistical method of determining the number of viable microorganisms, or of functional biomolecules, e.g. in DNA determination.
Cartridge: The expression “cartridge” is used as a generic term for the microfluidic component wherein the dilution series is produced in an automated manner and may be passed on, if need be, and it includes both a body of rotation and a fluidic module which, when inserted into a rotor, forms a body of rotation.

Embodiments of the invention enable production of dilution series whose the dilution factor Z may be defined by the user. The cartridge that may be used for this may contain exclusively passive geometric elements. Actively controlled valves are not required. A solution A (having a volume V_{A}) and a solution B (having a volume V_{B}) are added. The solution B may initially be split up into several “portions” specified by the fluidic structures (V_{B1}, V_{B2}, V_{B3} . . . with the sum ΣV_{Bi}≦V_{B}). The solution to be diluted A is now added to the portion V_{B1} and mixed. A mixture having the dilution factor Z₁=(V_{A}+V_{B1})/(V_{A}) is produced. Subsequently, a volume V_{AB1} of the dilution AB₁ is transferred into the portion V_{B2} and produces a Z₂=(V_{AB1}+V_{B2})/(V_{AB1}), etc. By further successive transferral of a volume V_{AB(i-1)} of a dilution AB₍ᵢ₋₁₎ into a portion V_{Bi} for producing the dilution ABᵢ, an indirect dilution series may thus be produced. The respective dilution factor Zᵢ is derived step by step from the preceding dilution factor Z₍ᵢ₋₁₎ and is defined by Zᵢ=(V_{AB(i-1)}+V_{Bi})/(V_{AB(i-1)})*Z₍ᵢ₋₁₎.

In embodiments of the invention, the respectively transferred volume V_{ABi} corresponds to the initially added volume V_{A} of the solution A. Likewise, in embodiments of the invention, all of the volumes V_{Bi} are identical to one another and, therefore, equal to the first volume V_{B1} of the solution B in the first mixing chamber. With this configuration, the respective dilution factor of the respective stage results with Zᵢ=(V_{A}+V_{B1})/(V_{A})*Z₍ᵢ₋₁₎=[(V_{A}+V_{B1})/V_{A}]ⁱ. In embodiments of the invention, the user has the possibility of adjusting the dilution factor by adding a defined amount of the solution A.

This shall be explained below with reference to three numerical examples.

### 1^{st} Numeric Example

Different volumes of V_{Bi}, and different transfer volumes V_{ABi}:

### Exemplary Cartridge:

Three mixing chambers comprising volumes V_{B1}=30 μl, V_{B2}=60 μl and V_{B3}=120 μl;

Transfer volumes V_{AB1}=20 μl, V_{AB2}=45 μl

### Application 1:

Addition of V_{A}=15 μl results in Z₁=3; Z₁=12 and Z₁=48

V_{B}≧ΣV_{Bi}≧210 μl of the solution B is inserted into the cartridge, and the chambers 1 to 3 are filled with the volumes V_{B1}=30 μl, V_{B2}=60 μl and V_{B3}=120 μl. Any volume of the solution B that is not required is transferred into a waste chamber. The solution A with V_{A}=15 μl is added into the mixing chamber 1. This results in Z₁=(15+30)/15=3. V_{AB1}=201 are now transferred from the mixing chamber 1 to the mixing chamber 2. What results is Z₂=(20+60)/20*3=12. V_{AB2}=40 μl are now transferred from the mixing chamber 2 to the mixing chamber 3. What results is Z₃=(40+120)/40*12=48.

### Application 2:

Addition of V_{A}=30 μl results in Z₁=2; Z₁=8 and Z₁=32

V_{B}≧ΣVBi≧210 μl of the solution B is introduced into the cartridge, and the chambers 1 to 3 are filled with the volumes V_{B1}=30 μl, V_{B2}=60 μl and V_{B3}=120 μl. Any volume of the solution B that is not required is transferred into a waste chamber. The solution A with V_{A}=30 μl is added into the mixing chamber 1. What results is Z₁=(30+30)/30=2. V_{AB1}=20 μl are now transferred from the mixing chamber 1 to the mixing chamber 2. What results is Z₂=(20+60)/20*2=8. V_{AB2}=401 are now transferred from the mixing chamber 2 to the mixing chamber 3. What results is Z₃=(40+120)/40*8=32.

### 2^{nd} Numeric Example

Different volumes of V_{Bi}, and transfer volume V_{ABi} identical to V_{A}:

### Exemplary Cartridge:

Three mixing chambers with volumes V_{B1}=30 μl, V_{B2}=60 μl and V_{B3}=120 μl
Transfer volume V_{AB1}=V_{AB2}=V_{A}

### Application 1:

Addition of V_{A}=15 μl results in Z₁=3; Z₁=15 and Z₁=135

V_{B2}≧ΣV_{Bi}≧210 μl of the solution B is introduced into the cartridge, and chambers 1 to 3 are filled with the volumes V_{B1}=30 μl, V_{B2}=60 μl and V_{B3}=120 μl. Any volume of the solution B that is not required is transferred into a waste chamber. The solution A with V_{A}=15 μl is added into the mixing chamber 1. What results is Z₁=(15+30)/15=3. V_{AB1}=15 μl are now transferred from the mixing chamber 1 to the mixing chamber 2. What results is Z₂=(15+60)/15*3=15. V_{AB2}=15 μl are now transferred from the mixing chamber 2 to the mixing chamber 3. What results is Z₃=(15+120)/15*15=135.

### Application 2:

Addition of V_{A}=30 μl results in Z₁=2; Z₁=6 and Z₁=30

V_{B}≧ΣVBi≧210 μl of the solution B is introduced into the cartridge, and the chambers 1 to 3 are filled with the volumes V_{B1}=30 μl, V_{B2}=60 μl and V_{B3}=120 μl. Any volume of the solution B that is not required is transferred into a waste chamber. The solution A with V_{A}=30 μl is added into the mixing chamber 1. What results is Z₁=(30+30)/30=2. V_{AB1}=30 μl are now transferred from the mixing chamber 1 to the mixing chamber 2. What results is Z₂=(30+60)/30*2=6. V_{AB2}=30 μl are now transferred from the mixing chamber 2 to the mixing chamber 3. What results is Z₃=(30+120)/30*6=30.

### 3^{rd} Numeric Example

Identical volumes V_{Bi}=V_{B1}, and transfer volume V_{ABi} identical to V_{A}:
This is the configuration for producing logarithmic dilution series.

### Exemplary Cartridge:

3 mixing chambers with volumes V_{B1}=V_{B2}=V_{B3}=30 μl
Transfer volume V_{AB1}=V_{AB2}=V_{A}

### Application 1:

Addition of V_{A}=15 μl results in Z₁=3; Z₁=9 and Z₁=27 (3̂1; 3̂2; 3̂3)

V_{B}≧ΣVBi≧90 μl of the solution B is introduced into the cartridge, and the chambers 1 to 3 are filled with the volumes V_{B1}=30 μl, V_{B2}=30 μl and V_{B3}=30 μl. Any volume of the solution B that is not required is transferred into a waste chamber. The solution A with V_{A}=15 μl is added into the mixing chamber 1. What results is Z₁=(15+30)/15=3. V_{AB1}=15 μl are now transferred from the mixing chamber 1 to the mixing chamber 2. What results is Z₂=(15+30)/15*3=9. V_{AB2}=15 μl are now transferred from the mixing chamber 2 to the mixing chamber 3. What results is Z₃=(15+30)/15*9=27.

### Application 2:

Addition of V_{A}=30 μl results in Z₁=2; Z₁=4 and Z₁=8 (2̂1; 2̂2; 2̂3)

V_{B}≧ΣVBi≧90 μl of the solution B is introduced into the cartridge, and the chambers 1 to 3 are filled with the volumes V_{B1}=30 μl, V_{B2}=30 μl and V_{B3}=30 μl. Any volume of the solution B that is not required is transferred into a waste chamber. The solution A with V_{A}=30 μl is added into the mixing chamber 1. What results is Z₁=(30+30)/30=2. V_{AB1}=30 μl are now transferred from the mixing chamber 1 to the mixing chamber 2. What results is Z₂=(30+30)/30*2=4. V_{AB2}=30 μl are now transferred from the mixing chamber 2 to the mixing chamber 3. What results is Z₃=(30+30)/30*4=8.

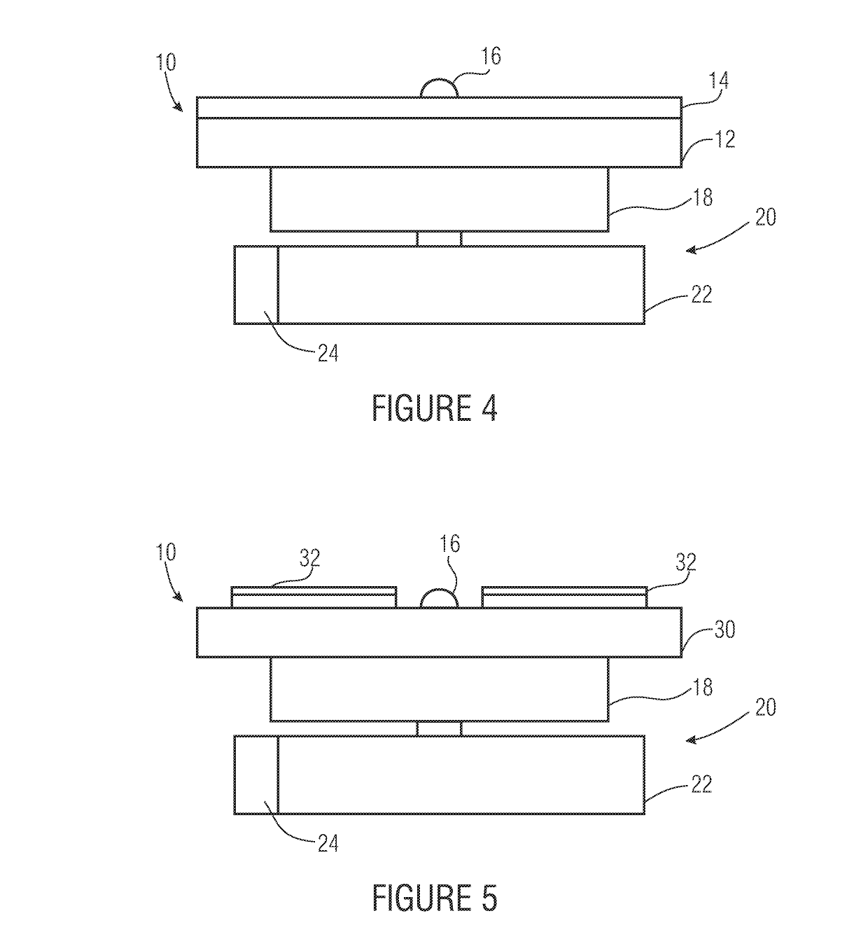

FIGS. 4 and 5 schematically show embodiments of devices for producing a dilution series.

FIG. 4 shows a body of rotation 10 comprising a substrate 12 and a lid 14. The substrate 12 and the lid 14 may be circular, in a top view, comprising a central opening, via which the body of rotation may be mounted to a rotating part 18 of a driving device 20 by means of a common attachment means 16. The rotating part 18 is pivotally mounted to a stationary part 22 of the driving device 20. The driving device may be a conventional centrifuge having an adjustable rotational speed, or a CD or DVD drive, for example. A control means 24 is provided which is configured to control the driving device 20 to subject the body of rotation 10 to rotations at different rotational speeds. As is obvious to persons skilled in the art, the control means 24 may be implemented by a computing means programmed accordingly, or by a user-specific integrated circuit, for example. The controller 24 may further be configured to control the driving device 20 upon manual inputs on the part of a user so as to effect the rotations of the body of rotation. In any case, the control means is configured to control the driving device to subject the body of rotation to the adequate rotation protocols so as to implement the invention as it is described herein. A conventional centrifuge having only one direction of rotation may be used as the driving device 20.

The body of rotation 10 comprises the fluidic structures that may be used for producing the dilution series. For example, the fluidic structures may be formed by cavities and channels within the substrate 12. Alternatively, the fluidic structures may be formed by cavities and channels within the substrate 12 and the lid 14. In embodiments, the fluidic structures are formed within the substrate 12, and fill-in openings and venting openings are formed in the lid 14.

In an alternative embodiment shown in FIG. 5, the body of rotation 10 comprises a rotor 30 and fluidic modules 32 inserted into the rotor 30. The fluidic modules 32 may each comprise a substrate and a lid, in which, again, the fluidic structures that may be used for producing the dilution series may be formed. The rotor 30 and the fluidic modules 32 form the body of rotation, which in turn may be subjected to a rotation by the driving device 20, which is controlled by the control means 24.

In embodiments of the invention, the body of rotation and/or the fluidic module, which comprises the fluidic structures, may be formed from any suitable material, for example a plastic such as PMMA (polymethyl methacrylate), polycarbonate, PVC (polyvinyl chloride) or PDMS (polydimethylsiloxane), glass or the like, for example.

The body of rotation may be considered as being a centrifugal microfluidic platform.

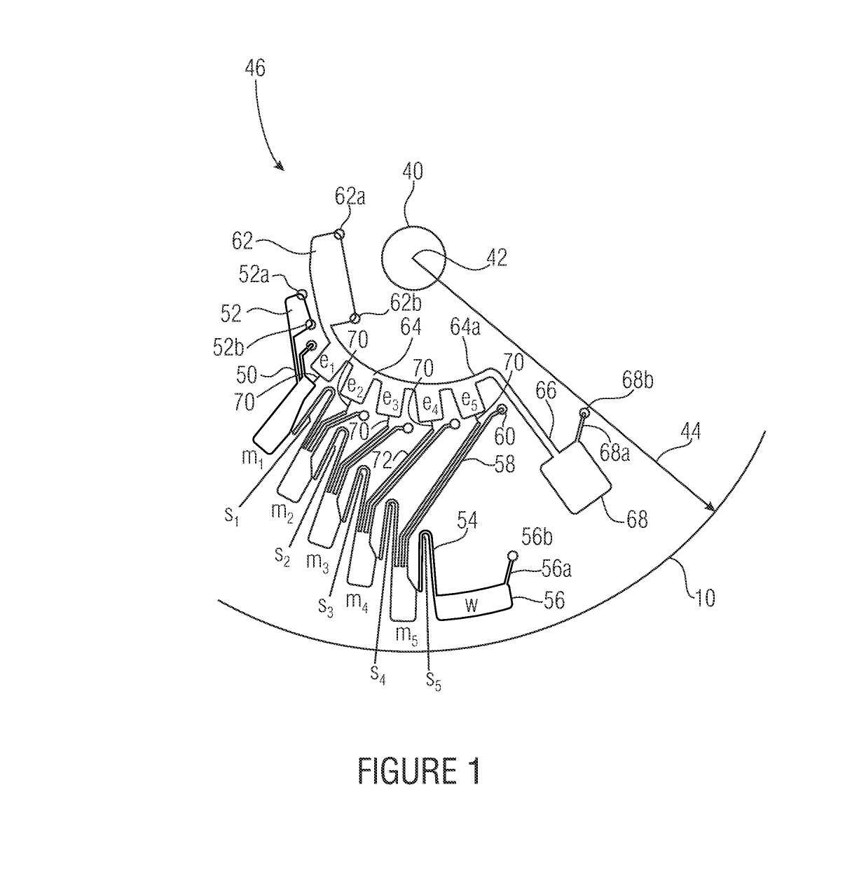

FIG. 1 shows a schematic top view of a section of an embodiment of the body of rotation 10 in the form of a disc comprising a central opening 40. In FIG. 1, only a segment of the disc is depicted. The center of the disc represents the center of rotation 42 of the body of rotation 10. A radially falling direction is depicted by an arrow 44 in FIG. 1, and it is the direction from the center of rotation 42 to the edge of the body of rotation 10. The body of rotation comprises fluidic structures 46, as will be explained below. Upon rotation of the body of rotation, a radially outwardly directed centrifugal force acts upon liquids located within the fluidic structures 46, so that liquids contained within the fluidic structures 46 may be centrifugally driven.

The fluidic structures 46 comprise five mixing chambers m₁ to m₅. The first mixing chamber m₁ is fluidically connected to a first inlet chamber 52 via an inlet channel 50. An inlet opening 52a and a venting opening 52b for the first inlet chamber 52 are provided, for example within a lid of the body of rotation. The first mixing chamber m₁ is connected to the second mixing chamber m₂ via a first fluidic connection s₁. The second mixing chamber m₂ is connected to the third mixing chamber m₃ via a second fluidic connection s₂, the third mixing chamber m₃ is connected to the fourth mixing chamber m₄ via a third fluidic connection s₃, and the fourth mixing chamber m₄ is connected to the fifth mixing chamber m₅ via a fourth fluidic connection s₄. The fifth mixing chamber m₅ is fluidically connected, via an outlet channel 54, to a waste chamber 56 which is fluidically connected to a venting opening 56b via a venting channel 56a. Each of the mixing chambers m₁ to m₅ is also connected to a venting opening 60 via a corresponding venting channel 58; for clarity's sake, only the venting channel 58 and the venting opening associated with the fifth mixing chamber are provided with a reference numeral in FIG. 1.

The fluidic structures 46 further comprise a second inlet chamber 62, for which, in turn, an inlet opening 62a and a venting opening 62b may be provided. The second inlet chamber 62 is fluidically connected to an aliquoting structure comprising a channel 64 and dosing chambers e₁ to e₅. A radially outer end 66 of the channel 64 is connected to a further waste chamber 68, which is fluidically connected to a venting opening 68b via a venting channel 68a.

A radially outer area of each of the dosing chambers e₁ to e₅ is fluidically connected, via a respective valve 70, to a radially inner area of an associated one of the mixing chambers m₁ to m₅. The dosing chambers e₁ to e₅ represent aliquoting fingers in the form of radially outwardly arranged protrusions of the channel 64, the channel 64 exhibiting a radially falling curve from the inlet chamber 62 to an area 64a located downstream, in terms of the flow direction, from the fifth dosing chamber es. Thus, the aliquoting structure enables, upon rotation of the body of rotation, that a defined liquid volume is retained within each of the dosing chambers e₁ to e₅, whereas excess liquid is sheared off and gets into the waste chamber 68.

The valves 70 may be formed by a hydrophobic bottleneck, for example, which enables passing of a liquid, e.g. a dilution solution, only from a specific rotational speed. In the embodiment shown, the valves associated with the mixing chambers m₂ to m₅ are fluidically connected to the mixing chambers via respective fluid channels, a fluid channel associated with the mixing chamber m₄ being designated by the reference numeral 72 by way of example.

In the embodiment shown in FIG. 1, the fluidic connections s₁ to s₅ are formed as siphon structures. Each of the siphon structures has a capillary fluid channel comprising a fluid inlet and a fluid outlet, the fluid inlet leading into a preceding mixing chamber, and the fluid outlet leading into a subsequent mixing chamber. The capillary fluid channel of the siphon structure comprises, in a common manner, a radially inwardly extending portion and a radially outwardly extending portion.

The fluid inlet of each siphon structure leads into the preceding mixing chamber at a location that is radially further inward than that where the fluid outlet leads into the subsequent mixing chamber. Thus, the siphon structures enable, when passing through a suitable rotation protocol, emptying of the liquid volume of the preceding mixing chamber, which leads into the subsequent mixing chamber radially inward of that position where the fluid inlet of the siphon structure leads into the mixing chamber. In this manner, following such a partial emptying, a defined liquid volume remains in the preceding mixing chamber. Thus, the mixing chambers m₁ to m₅ are each configured to retain a defined liquid volume following partial emptying into the respectively subsequent mixing chamber.

Partial emptying of the mixing chambers may be effected by passing through a corresponding rotation protocol. If the centrifugal force caused by a rotation is larger than the capillary force acting within the capillary fluid channel of the siphon structure, capillary filling of the siphon will be prevented and no partial emptying will take place. If the rotational frequency is reduced such that the capillary force is larger than the centrifugal force, capillary filling of the siphon structure will take place. Moreover, if, following the capillary filling of the siphon structure, the centrifugal force is sufficient to overcome a meniscus at the fluid outlet of the siphon structure, partial emptying of the preceding mixing chamber, as was described above, will take place. This may be effected by increasing the rotational frequency following the capillary filling of the siphon structure.

As may be seen in FIG. 1, the mixing chambers are arranged in a radially falling manner starting from the first mixing chamber m₁. Put differently, those areas of the mixing chambers which retain the defined liquid volume are arranged increasingly radially further outward from the first to the fifth mixing chambers. When speaking of two mixing chambers, the preceding mixing chamber is understood to mean that mixing chamber which is arranged radially further inward, whereas the subsequent mixing chamber is understood to mean that which is arranged radially further outward.

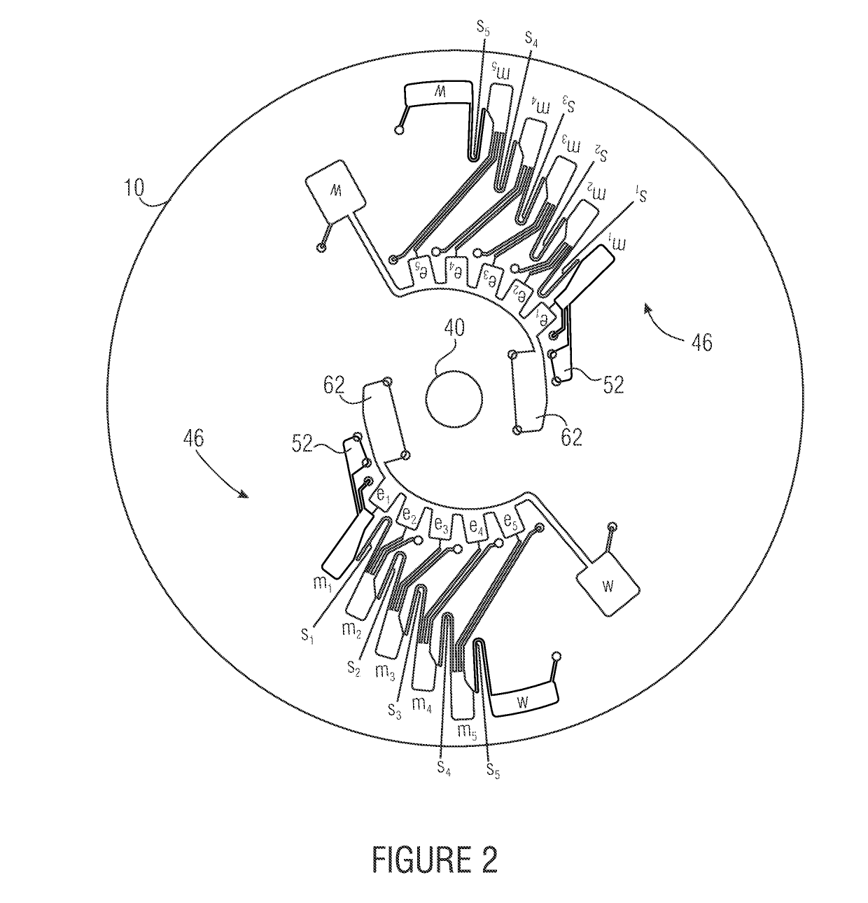

FIG. 2 shows an embodiment of a body of rotation wherein the fluidic structures 46 are provided twice, so that two dilution series may be produced at the same time. It is obvious to persons skilled in the art that it is also possible for a larger number of fluidic structures to be azimuthally distributed on the body of rotation given sufficient space. In embodiments, several fluidic modules, each of which comprises corresponding fluidic structures, may be inserted in a rotor in an azimuthally distributed manner.

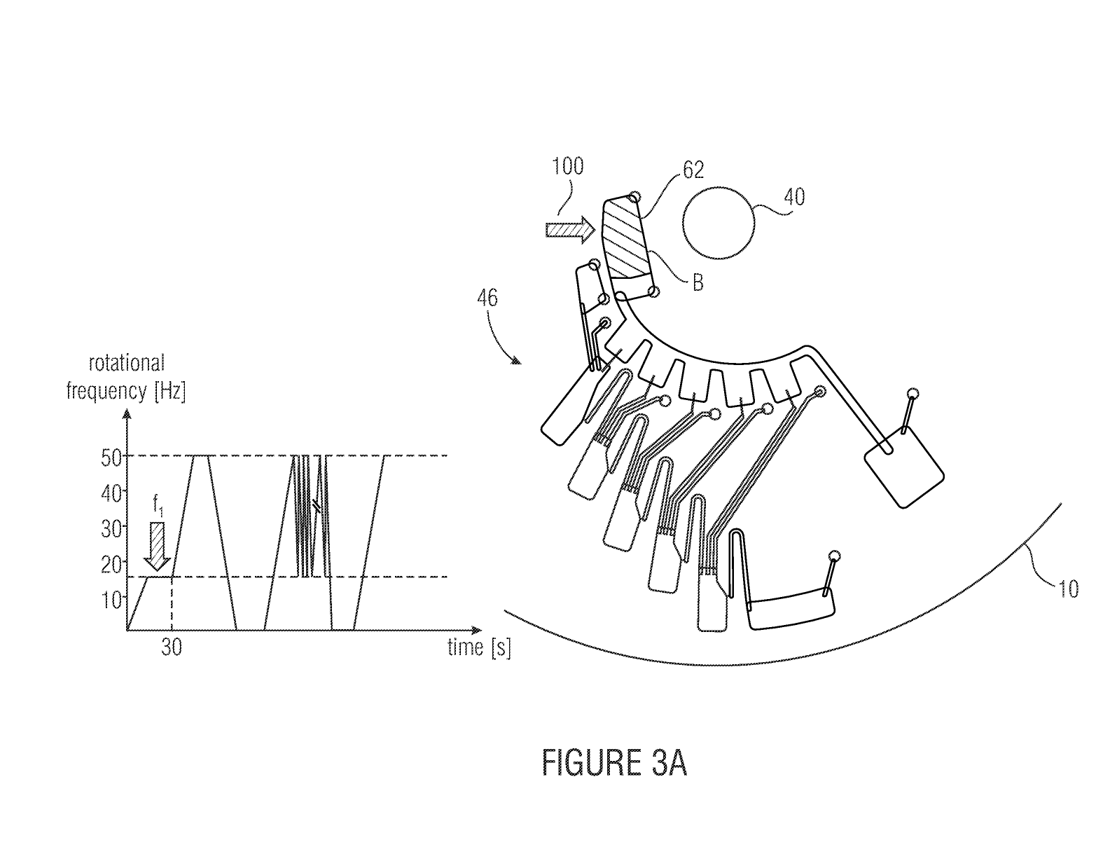

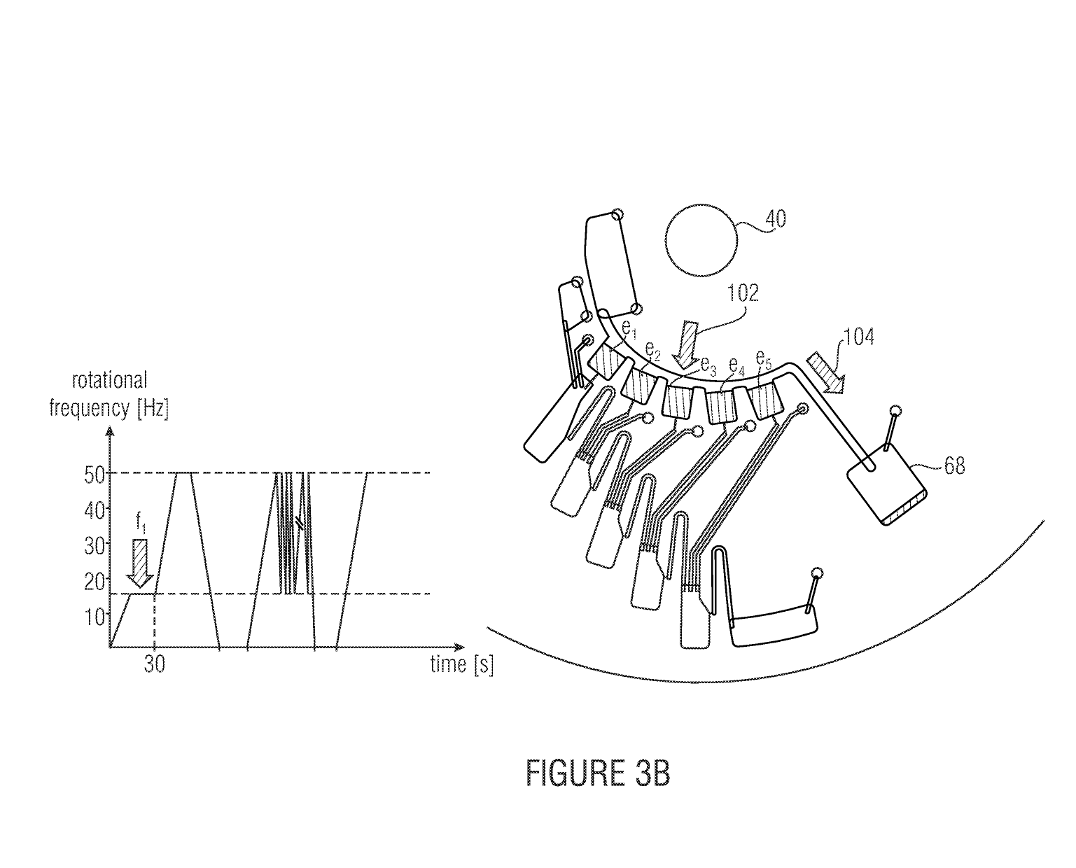

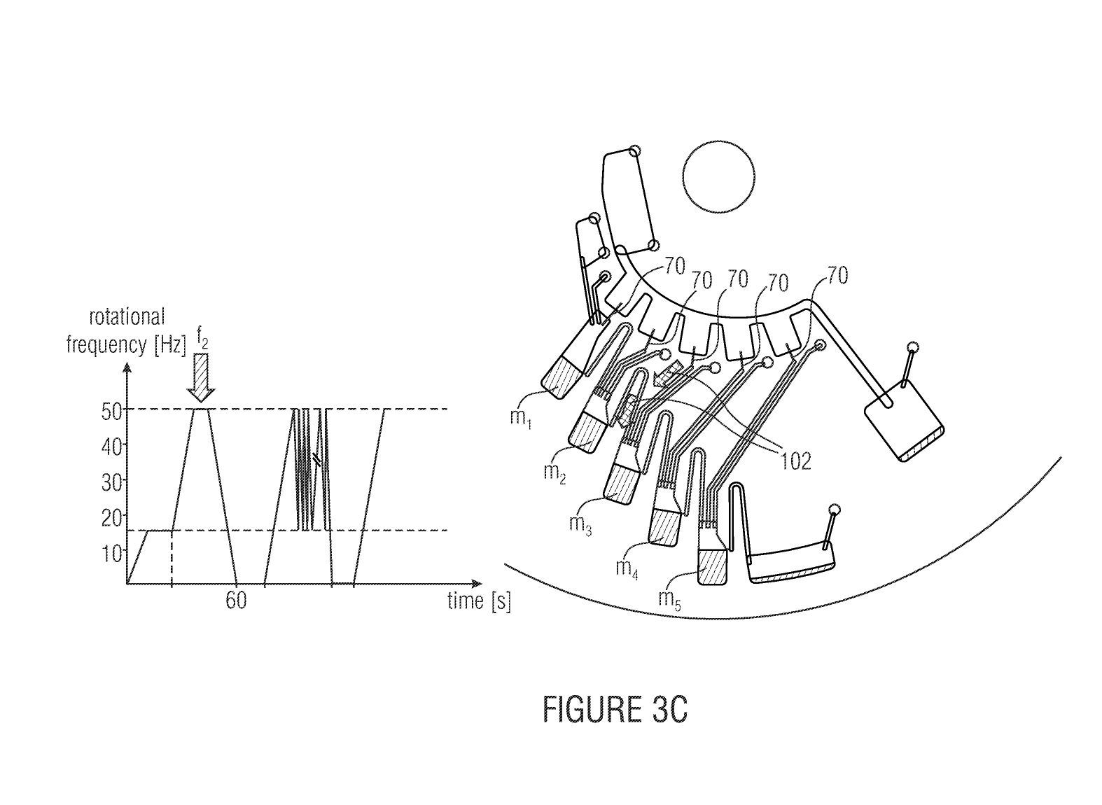

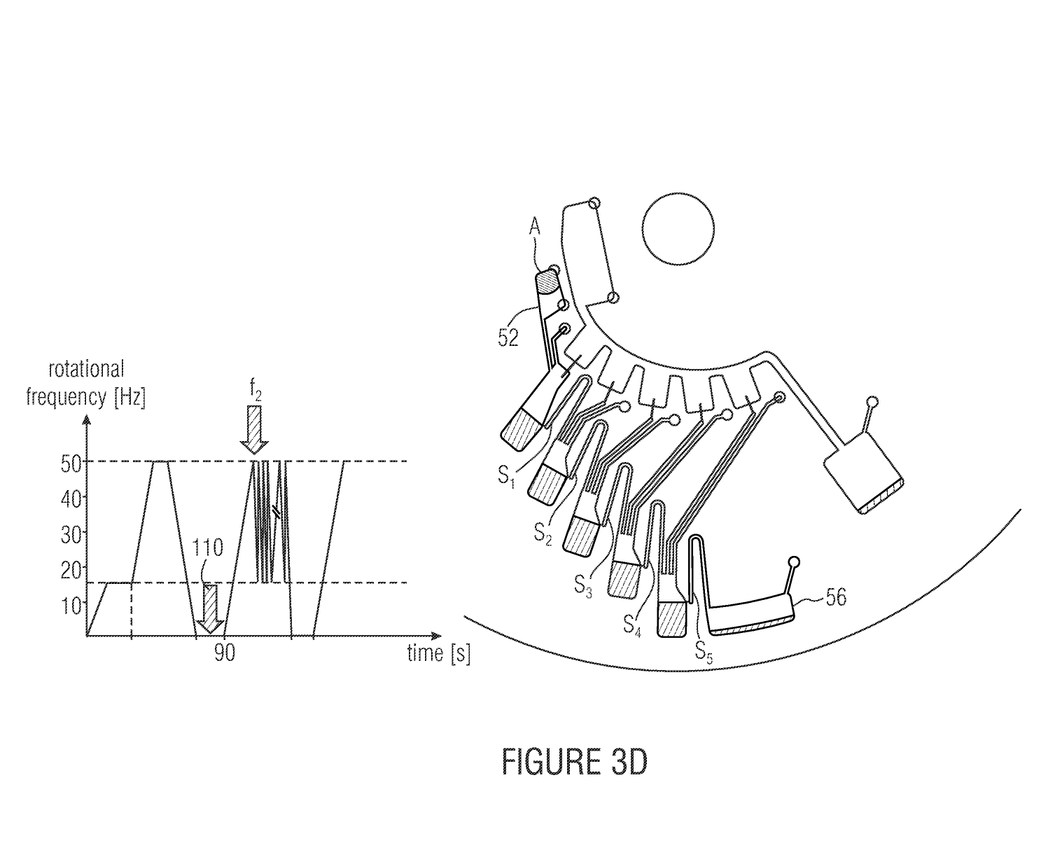

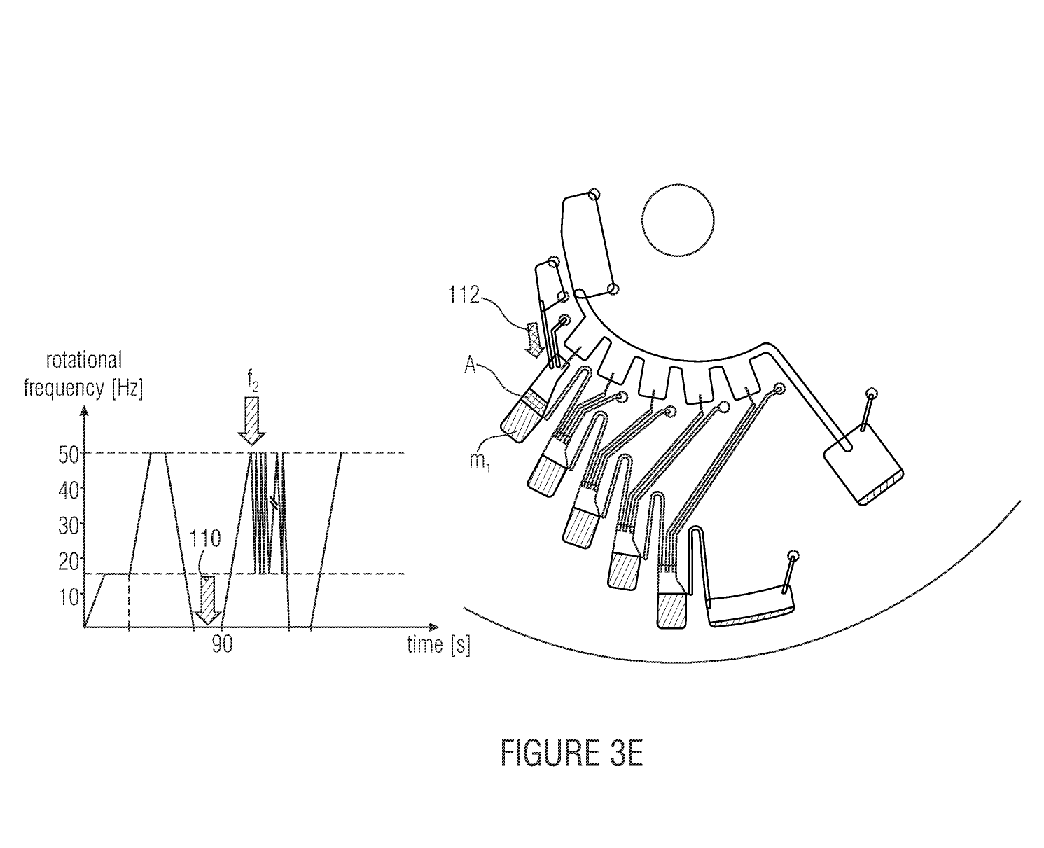

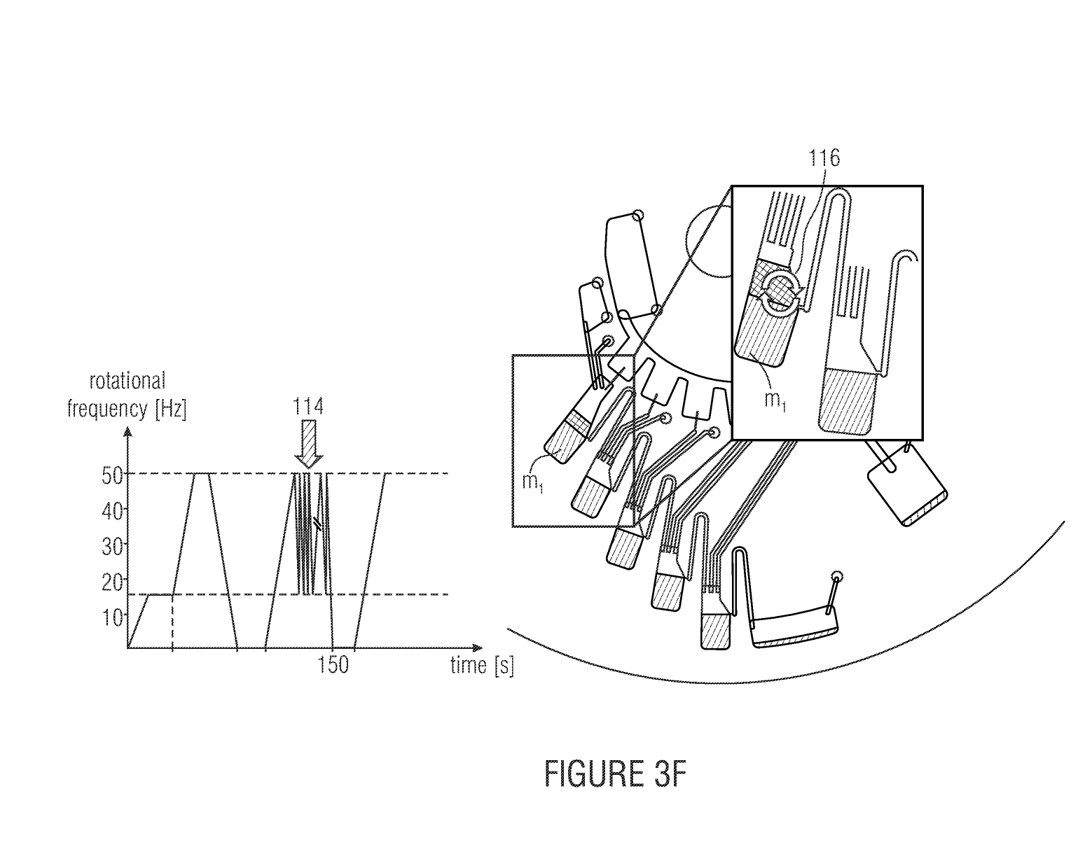

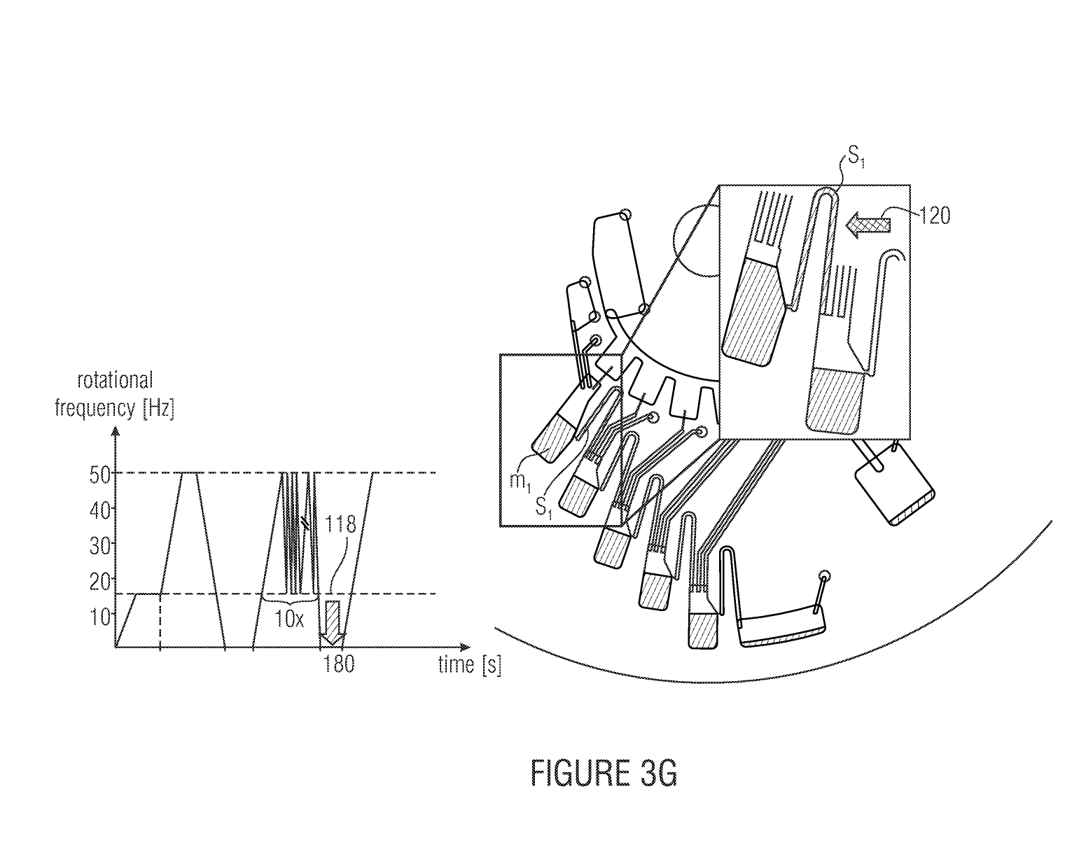

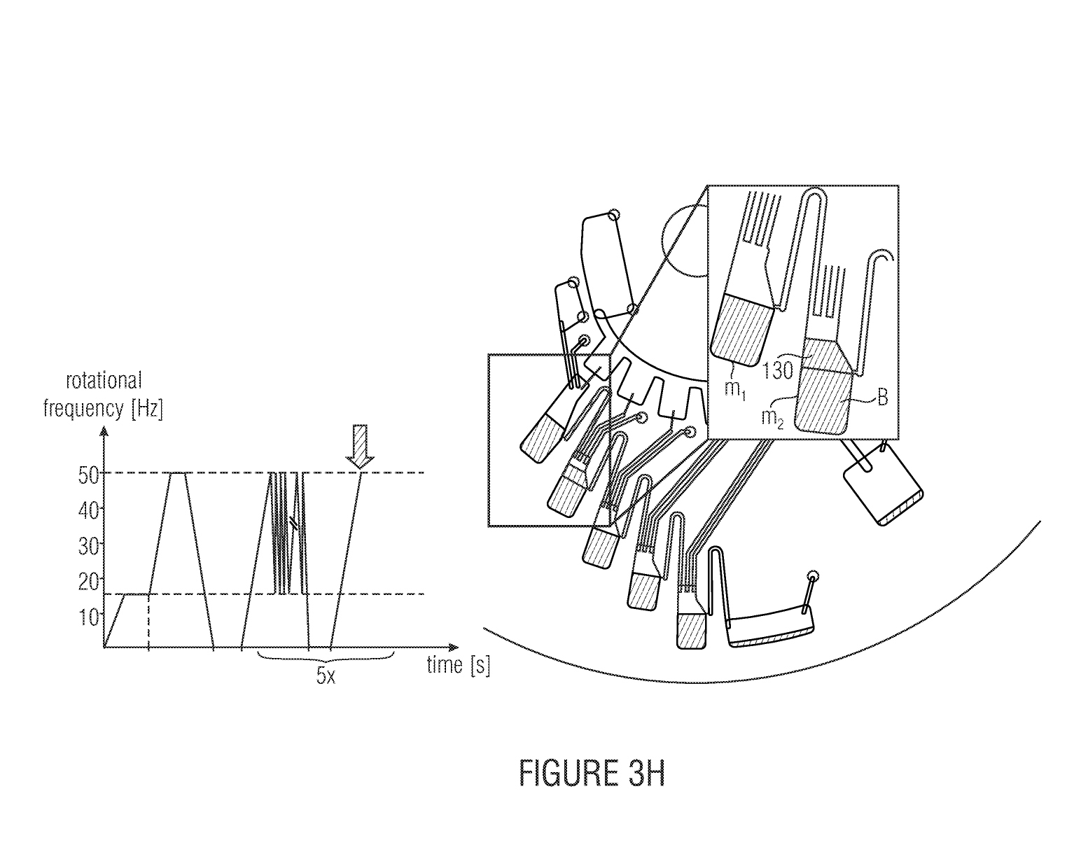

The mode of operation of the embodiment shown in FIG. 1, as well as an embodiment of a method of producing a dilution series, will now be explained in terms of producing several discrete dilutions of a solution A, which represents a solution to be diluted which contains a substance to be diluted, and of a solution B, which represents a dilution solution, with reference to FIGS. 3a to 3h. The right-hand parts of each of FIGS. 3a to 3h show the body of rotation 10 comprising the fluidic structures 46, and the left-hand parts show a frequency protocol depicting the rotation protocols that are passed through.

In the example described, the volumes Vᵢ of the individual dilutions are nominally identical since the respective dosing chambers and mixing chambers are configured to provide identical liquid volumes. However, in alternative embodiments, any volumes Vᵢ are possible by configuring the chambers accordingly.

Controlling of the liquids, i.e. transport, volume determination, mixing, etc., is performed by corresponding frequency protocols of the rotation of the body of rotation (of the cartridge) and is based on the interplay of the forces resulting therefrom, i.e. centrifugal forces, inertial forces and capillary forces. One important advantage of embodiments of the invention consists in that no active components such as valves to be switched actively, for example, are required in the body of rotation. As has already been explained, a standard laboratory centrifuge may be utilized as a drive and as a controller.

As is shown in FIG. 3a by an arrow 100, the solution B is initially filled into the second inlet chamber 62. The solution B may be filled in manually or automatically, for example by a pipetting machine.

As is shown in the left-hand parts of FIGS. 3a and 3b, the controller controls the drive to perform a defined rotation at a frequency f₁ (of 15 Hz, for example). This results in that the total volume V_{B} of the solution B is split up into several individual volumes, so-called aliquots, having defined volumes V_{Bi} in the dosing chambers e₁ to e₅, as is indicated by an arrow 102 in FIG. 3b. The supernatant is transferred into the waste chamber 68, arrow 104. Rotation at the frequency f₁ may be regarded, e.g., as a rotation in accordance with a fifth rotation protocol.

Subsequently, the controller effects an increase in the rotational speed to a frequency f₂ (f₂>f₁), as may be seen in the left-hand part of FIG. 3c. For example, f₂ may be 50 Hz. The centrifugal force generated by the rotation at the frequency f₂ is sufficient to overcome the resistance of the hydrophobic bottlenecks of the valves 70, so that each individual volume V_{Bi} of the solution B is transferred from the dosing chambers e₁ to e₅ into one of the mixing chambers m₁ to m₅. Rotation at the frequency f₂ may be regarded, e.g., as a rotation at a fourth rotation protocol.

Following this, the controller controls the drive to stop the rotation, see the arrow 110 in the left-hand part of FIG. 3d. If needed, a supernatant of the solution B may get into the waste chamber 56 through the fluidic connections s₁ to ss.

Once the rotation has been stopped, a volume V_{A}, defined by the user, of the solution A is filled into the inlet chamber A, which, in turn, may be effected manually or automatically. The defined volume V_{A} determines the dilution factor. Following this, acceleration takes place again, e.g. to the rotational frequency f₂, as a result of which the solution A is transferred into the first mixing chamber m₁, as is shown by the arrow 112 in FIG. 3e.

Once the solution A has arrived in the first mixing chamber m₁, the controller causes the rotational frequencies to alternately switch 114 between f₁ and f₂, which results in the solution A being mixed 116 with the precharged solution B in the mixing chamber m₁ due to inertia, as is depicted in FIG. 3f. For example, the rotational frequencies f₁ and f₂ may switch ten times. The alternating switches of the rotational frequencies may be regarded as a first rotation protocol.

Once the solutions, or substances, have been homogenously mixed, a defined volume of the mixture produced will be transferred into the neighboring chamber. To this end, the rotational frequency is reduced, by the controller, to such an extent, e.g. stopped 118, that the capillary siphon s₁ is capillarily filled, as is indicated by an arrow 120 in FIG. 3g. As has already been explained, at a standstill and at low rotational frequencies, capillary forces will enable the siphon to be filled with liquid, whereas at elevated frequencies, the centrifugal force will dominate over the capillary force, and capillary filling will not be possible. If complete filling takes place due to low centrifugal forces, a subsequent increase in the acceleration will lead to liquid being transported from the radially inwardly located input of the siphon to the radially outwardly located end. The inputs of the siphons s₁ to s₅ are connected, on the body of rotation, to a respective one of the mixing chambers m₁ to m₅ such that only a defined volume of the dilution located therein is introduced into the respectively subsequent mixing chamber. This volume is determined by the specific radial position where the respective siphon structure starts in the mixing chamber m₁. The volume transferred from the chamber n₍ᵢ₋₁₎ into the chamber mᵢ is defined by this. The corresponding rotation protocol for transferring the partial volume from the mixing chamber m₁ into the mixing chamber m₂ may be regarded as a second rotation protocol.

The state following the transfer of the defined partial volume 130 into the second mixing chamber is shown in FIG. 3h. Thereafter, the controller effects a third rotation protocol wherein the solution B precharged in the second mixing chamber m₂ and the partial volume 130 are mixed. The third rotation protocol may be the same as the first rotation protocol.

The corresponding rotation protocols (rotation protocols 1 to 3) may then be repeated so as to produce further dilutions in the mixing chambers m₃ to m₅.

The type of transfer of liquid described enables producing dilutions having different dilution factors by using a geometrically specified body of rotation, or cartridge, by adding a variable amount of the solution A. The dilution factor is determined only by the amount of solution A added. It is possible to serially produce several dilutions, the number of dilution stages being limited essentially by the size of the body of rotation. A specific embodiment of producing a dilution series for an addition of 7.5 μl (I) and 15 μl (II), respectively, of the solution A will now be described by means of a numeric example. In the following, solution A is to contain any bacterium at a concentration of c=10,000 items/μl. 200 μl of a solution B are introduced into the inlet chamber 62, and the frequency protocol is started. Due to centrifugal forces, solution B is split up into individual aliquots in the dosing chambers e₁ to e₅ having a volume of 30 μl each. The supernatant flows into the waste chamber 68. The frequency is increased, and the aliquots are transferred from the dosing chambers e₁-e₅ into the mixing chambers m₁-m₅. The volumes of the dosing chambers e₁-e₅ are determined such that each mixing chamber is now filled up to the lower edge of the capillary siphons s₁-s₅. Rotation is stopped, and the respective initial volumes 7.5 and 15 μl of the solution A are introduced into the inlet chamber 52. Repeated rotation transfers the solution A into the mixing chamber m₁ where it is mixed with the precharged 30 μl of the solution B. Now the liquid level of the chamber is increased, and the capillary siphon s₁ may fill up during standstill. After repeated rotation, the initial volumes of the solution A, i.e. exactly 7.5 and 15 μl, respectively, of the produced dilution AB₁ are transferred from the mixing chamber m₁ into the mixing chamber m₂, where they are also mixed with the precharged 30 μl of the solution B, etc., as is set forth in the following Table 1.

TABLE 1

| | | Initial | | Initial |
|---|---|---|---|---|
| | Volume of | concentration | Volume of | concentration |
| | solution | 10,000 items/μl | solution | 10,000 items/μl |
| | A = 6 μl | Concentration | A = 15 μl | Concentration |
| | Dilution | in items/ | Dilution | in items/ |
| | factor Zᵢ | μl | factor Zᵢ | μl |
| Chamber m₁ | 6 | 1666.7 | 3 | 3333.3 |
| Chamber m₂ | 36 | 277.8 | 9 | 1111.1 |
| Chamber m₃ | 216 | 46.3 | 27 | 370.4 |
| Chamber m₄ | 1296 | 7.7 | 81 | 123.5 |
| Chamber m₅ | 7776 | 1.3 | 243 | 41.2 |

Table 1 shows the dilution factors and bacteria concentrations of the individual dilutions in the mixing chambers m₁ to m₅ for additions of 6 μl and 15 μl, respectively, of the solution A and upon precharging of 30 μl of the solution B in each mixing chamber.

In alternative embodiments of the invention, the fill-in chambers for the dilution solution and the solution to be diluted may be implemented and/or connected to the remaining fluidics such that both the solution to be diluted and the dilution solution may be precharged simultaneously prior to the start of the frequency protocol. An interruption of the rotation once the dilution solution has been processed, i.e. once the dilution solution has been introduced into the mixing chambers, would then no longer be necessary.

Instead of the aliquoting structure shown in FIG. 1 for the dilution solution, the entire volume of the dilution solution might initially be fed into the mixing chamber m₁. Due to the reduction of the rotational frequency to below the critical frequency at which the siphons fill, and to subsequent rotation above the critical frequency, a volume definition is also effected in the chamber m₁. If this cycle is repeated several times, all of the mixing chambers m₁ to m₅ will thereafter be filled with a defined volume defined by the siphon structure in the mixing chamber. In such embodiments, it is after the dilution solution in the mixing chamber m₁ has been portioned, at the earliest, that the solution to be diluted is transferred into the mixing chamber m₁, where it is mixed with the dilution medium.

In alternative embodiments of the invention, integrated pre-portioning of the solution to be diluted may be provided. For example, the inlet or the inlet chamber for the solution to be diluted (solution A) of the cartridge may be combined with a fluidic structure for defined volume determination, so that the solution to be diluted need only be added in excess. The starting volume of the solution to be diluted may thus also be determined automatically and without any influence of manual pipetting. In embodiments, several inlets for the solution to be diluted may be implemented on a cartridge, each of the inlets being designed for a different kind of pre-portioning, so that a desired dilution series may be produced by selecting one of the inlets. Thus, the solution to be diluted may be portioned in accordance with the desired dilution series in each case, so that different dilution series may be produced with one single cartridge, as desired by the user.

In the embodiment described, neighboring mixing chambers are connected to one another by means of capillary siphons, which transfer a defined volume of one mixing chamber into the neighboring mixing chamber in each case. Alternatively, neighboring mixing chambers may also be connected to other suitable valves or transitions which enable initially mixing the liquids and then transferring a portion of the mixture into the next chamber. This may be achieved by a corresponding frequency protocol. The principle of producing dilution series is based on sequentially transporting a defined liquid volume from one mixing chamber into the neighboring mixing chamber.

In the embodiment described, a fluidic valve in the form of a hydrophobic bottleneck is provided between the dosing chambers and the mixing chambers. Alternatively, other suitable valves or transitions may be provided which allow or do not allow the dilution solution to pass, depending on the rotational frequency.

In embodiments of the invention, suitable fluidic structures may be provided in the body of rotation which enable discharging of the mixtures from the mixing chambers by means of further fluidic operations (standard operations). For using or processing the produced dilutions further, the individual mixing chambers may be connected, via suitable valves, to further fluidic elements on the body of rotation. In addition, there is the possibility of centrifuging the liquids in the mixing chamber via suitable valves from the body of rotation into collection vessels. As collection vessels, one might use, in particular, standard laboratory containers such as standard tubes (so-called Eppendorf cups having volumes of, e.g., 0.5 ml, 1 ml, 1.5 ml, 2 ml, Falkon tubes containing 15 ml or 50 ml) or microwell plates or vessels similar to microwell plates as well as relatively small sample containers such as PCR tubes. In embodiments of the invention, the dilutions produced may thus be further processed once the mixture has been produced on the body of rotation, and/or may be transferred into cavities located further outward, for example in enzymatics. In embodiments of the invention, the dilutions produced may be transferred, following mixing, from the body of rotation to outwardly located receptacles and/or containers which may be removed. Said receptacles may be standard laboratory receptacles such as Eppendorf cups, microwell plates and the like. In embodiments of the invention, a fluid output may be provided at a radially outer portion of one or more of the mixing chambers, which fluid output may be provided with a valve, so that the mixture in the mixing chamber may be transported out of the mixing chamber by subjecting the body of rotation to a rotational frequency at which the valve allows the mixture to pass.

Embodiments of the invention are suitable for diluting different starting solutions, depending on the application. The following solutions/mixtures to be diluted may be used for this purpose, among others:
Solutions containing nucleic acid (single-stand DNA, double-strand DNA, RNA), for example for determining the nucleic-acid content and/or for establishing calibration standards.
Protein-containing and other solutions, cell lysates or solutions derived therefrom, for example for determining concentrations, for determining IC50, LD50 or similar values, for determining equilibrium constants, for enzyme kinetics and/or for establishing calibration standards.
Emulsions, suspensions or mixtures, for example for dilutions or for creating different conditions of a phase-induced reaction such as polymerization of nano- and microparticles or stabilization of emulsions by adding different amounts of emulsifiers or stabilizers.

Suspensions containing cells and cellular constituents, for determining the number of germs, for determining constituents and/or for establishing calibration standards.

Applications of embodiments of the invention are in the field of enzyme kinetics. Both the enzyme and the substrate as well as inhibitors or activators may be diluted and be mixed with one another in end cavities by the structures described. This enables determining Michaelis-Menten constants, turnover numbers, IC50 values or other typical characteristics of enzyme kinetics. Thus it is possible to accurately characterize the enzyme used, the substrate and the inhibitor or activator.

Applications of embodiments of the invention are in the field of immunoassay calibration, the antigen of the immunoassay being diluted. In this manner, the corresponding immunoassay may be calibrated, and the detection limit or the quantification limit may be determined.

Applications of embodiments of the invention are in the field of the most probably number for germs. Germs such as bacteria, viruses or fungi, for example, are diluted, and the dilutions are aliquoted in end cavities. If the end cavities have entities located therein which are capable of growing, this is detected by a change (e.g. change in color, clouding, etc.). By means of determining the most probable number, one may estimate, from the dilutions produced and from the individual positive sub-volumes, how many germs were contained in the initial mixture.

Applications of embodiments of the invention are in the field of the most probable number for nucleic acids. Nucleic acids such as DNA or RNA are diluted, and the dilutions are aliquoted in end cavities. There, a PCR is performed. If the corresponding nucleic acid is located in the end cavity, a positive signal will be produced. By means of determining the most probable number, one may estimate, from the dilutions produced and from the individual positive aliquots, how many nucleic-acid molecules were contained in the initial mixture.

Embodiments of the invention provide semi-automatic or fully automatic production of discrete dilutions within a cartridge by means of centrifugation, e.g. within a conventional laboratory centrifuge. Since no external equipment (laser, infrared radiator) is required for actuating valves, standard laboratory equipment (centrifuges) are also suitable for operating the cartridge, which has been confirmed experimentally. No specific processing equipment is required.

The concentrations of the dilutions produced and/or the implemented dilution factors Z may be changed both by the layout and by the structures implemented in the cartridge (on the manufacturing side) as well as by the sample volume of the solution A added by means of pipetting (on the user side). This has already been shown experimentally. Thus, the dilution factors Z of the dilution series may be changed by the user, even after manufacturing of the cartridges. Z=(V_{A}+V_{B})/V_{A} shall continue to apply in this context. V_{B} is specified by the cartridge; V_{A} can either be freely varied on the part of the user or is also specified by the cartridge. Therefore, one does not need different microfluidic layouts in order to implement different Zs, which imparts a high measure of flexibility to the overall system, which also has already been confirmed experimentally.

In particular, however, one may produce dilution series wherein the dilution stages may be implemented fully automatically and without the influence of manual pipetting errors. To this end, fluidic structures for defining the volumes of the solution to be diluted A and of the dilution solution B are integrated into the cartridge in addition to the inlets for said solutions A and B. The solutions then only need to be added in excess. In this case, a highly accurate dilution series which is almost free from any manual pipetting errors (except for the case where an insufficient amount is pipetted in) may be implemented. In such embodiments, the dilution factor Z may be predefined by the fluidics, so that there is no free choice of the dilution factors Z on the part of the user.

Embodiments of the invention thus provide a centrifugal-microfluidic structure which implements a dilution series semi-automatically or fully automatically. In this context, the dilution solution B is split up into individual volumes V_{B1} to V_{Bn} (with n>1). A solution to be diluted A having the volume V_{A} is added and is diluted with V_{B1}. From this dilution, a volume V_{AB1} is transferred and diluted with a volume V_{B2}. Step by step, one volume V_{AB(i-1)} at a time is transferred and diluted with a volume V_{Bi}, and, thus, a dilution series with Zᵢ=((V_{AB(i-1)}+V_{Bi})/V_{AB(i-1)})*Z₍ᵢ₋₁₎ is produced, with i≦n and Z₀=1. Said mixing and transferring may be performed both serially and in parallel until all of the dilutions of the dilution series have been produced.

Embodiments of the invention provide a centrifugal-microfluidic structure implementing a dilution series. The dilution solution B is split up into individual volumes V_{B1} to V_{Bn} (with n>1). A solution to be diluted A having the volume V_{A} is added and diluted with V_{B1}. From this, a partial volume V_{AB1}=V_{A} is again transferred into the next volume V_{B2}. Step by step, one volume V_{AB(i-1)}=V_{A} at a time is transferred and mixed with a volume V_{Bi}. Said mixing and transferring is performed step by step until all dilutions have been produced. This results in a dilution series with Zᵢ=((V_{A}+V_{Bi})/V_{A})*Z₍ᵢ₋₁₎ with i≦n. With this layout, too, the user may change the dilution factors Zᵢ of the dilution series by means of choosing the volume V_{A}.

Embodiments of the invention provide a centrifugal-microfluidic structure implementing logarithmic dilution series. The dilution solution B is split up into individual volumes V_{B1} to V_{Bn} (with n>1), and all volumes be identical to V_{Bi}=V_{B1}. A solution to be diluted A having the volume V_{A} is added and diluted with V_{B1}. From this, a partial volume V_{AB}=V_{A} is again transferred into the next volume V_{B2}=V_{B1}. Step by step, one volume V_{AB(i-1)}=V_{A} at a time is transferred and mixed with a volume V_{Bi}=V_{B1}. Said mixing and transferring is performed step by step until all of the dilutions have been produced. This results in a dilution series with Zᵢ=((V_{A}+V_{B1})/V_{A})*Z₍ᵢ₋₁₎ with i≦n. This results in a Zᵢ=((V_{A}+V_{B1})/V_{A})̂ i, which corresponds to a logarithmic dilution series, with a dilution of ((V_{A}+V_{B1})/V_{A}) between individual concentrations. In this layout, too, the user may change the dilution factors Zᵢ of the dilution series by means of choosing the volume V_{A}.

In embodiments of the invention, the volume V_{Bi} is specified by microfluidics, whereas the volume V_{A} is determined by the user.

In embodiments of the invention, the volume V_{A} cannot be influenced by the user. The cartridge exhibits one or more inlets so as to therewith implement different dilution factors Z for advantageously logarithmic dilution series.

Embodiments of the invention comprise a rotating substrate having a plurality of microfluidic structures (fill-in chambers, mixing chambers, possibly siphons, possibly aliquoting structures, possibly passive valves). (a1) A fluidic channel connects one of the fill-in chambers for the dilution solution to a plurality of fluidic “fingers” having defined volumes. (a2) Said fingers may split up the initial amount of the solutions from the fill-in chamber into several sub-volumes. The supernatant of the solution is transferred into a supernatant chamber. Each of the fingers is connected to one mixing chamber in each case. As an alternative to (a1) and (a2), the fill-in chamber for the dilution solution may also be directly connected to the first mixing chamber m₁. Portioning may also be effected by serially transferring the supernatant of the solution into the respectively neighboring mixing chamber via the capillary siphons. A second fill-in chamber for the solution to be diluted is connected to one of the mixing chambers. A suitable fluidic connection is provided between neighboring mixing chambers in each case, for example a capillary siphon, so as to initially allow mixing and, subsequently, transferring of a portion of the mixture into the next mixing chamber.

In embodiments of the invention, the volumes of the dilution series are transferred from the cartridge to external containers. In embodiments of the invention, the external containers may be removed from the cartridge. In embodiments of the invention, the containers are standard laboratory containers such as Eppendorf cups, for example. In embodiments of the invention, the containers are microwell plates or parts of microwell plates. In embodiments of the invention, they are containers for nucleic-acid analytics or immunoassays. In embodiments of the invention, the volumes of the dilution series are further processed on the cartridge. In embodiments of the invention, the volumes are transferred into such cavities on the cartridge which are located further outward. In embodiments of the invention, the volumes are aliquoted and transferred, in each case, to one or more cavities on the cartridge which are located further outward. In embodiments of the invention, prior to or following transferral of the volumes of the dilution series, one or more further solutions are fed into the cavities located further outward. In embodiments of the invention, the solutions employed are an enzyme, a substrate, an inhibitor or an activator. In embodiments of the invention, the solutions employed are a nucleic acid or a solution containing nucleic acids. In embodiments of the invention, the solutions employed are a solution of molecules, emulsions or suspensions. In embodiments of the invention, the solutions employed contain germs (bacteria, viruses, fungi). In embodiments of the invention, the solutions employed contain particles. In embodiments of the invention, the structure is used for determining biochemical quantities and characteristics. In embodiments of the invention, the solution to be diluted contains nucleic acids, and the initial concentration of the nucleic acid is determined. In embodiments of the invention, the solution to be diluted contains proteins, and the initial concentration of the proteins is determined. In embodiments of the invention, the solution to be diluted contains germs, and the initial concentration of the germs is determined. In embodiments of the invention, the solution to be diluted contains an antigen or an antibody, and characteristic values/indices of an immunoassay are determined. In embodiments of the invention, the solution to be diluted contains an enzyme, and characteristic values of enzyme kinetics are determined (such as the Michaelis-Menten constant, turnover number, kinetics constants and conversion rates). In embodiments of the invention, the solution to be diluted contains an inhibitor or an activator, and characteristic values of enzyme kinetics are determined, such as the IC50 value. In embodiments of the invention, the solution to be diluted contains particles, and the initial particle concentration is determined.

Embodiments of the invention enable numerous substantial advantages over known approaches of producing dilution series.

### 1. Flexibility

Dilution factors of solutions A and B may be determined by the amount added of the solution to be diluted. Adaptation of the cartridge or of the structures integrated within the cartridge is therefore not necessary.
A logarithmic dilution series may be implemented by choosing identical volumes.

### 2. Relaxed System Requirements

Embodiments of the invention may be implemented on a customary centrifuge with only one single direction of rotation.
Low-cost production of the cartridges, for example by means of injection molding, is possible.
No actively controlled valves, no movable parts, no external actuation mechanisms are required.

### 3. Low Processing Costs

Standard laboratory equipment such as centrifuges, for example, is suitable for processing the cartridges.

### 4. High Degree of Automation

Full automation of the work cycle is possible by using suitable interfaces on the laboratory devices.
In embodiments of the invention, the production of the dilution series involves only manual pipetting-in of the solutions. The mixtures and the dilutions themselves are produced fully automatically by the frequency protocol.

### 5. Full Automation of Defined Dilutions is Possible

In embodiments of a specifically configured cartridge, the solution to be diluted may be charged in excess. The microfluidics contained may guarantee defined automatic portioning of the solution to be diluted. Since the precharged portions of the dilution solution are also predefined, said portioning volumes unambiguously specify the dilution factor Z for said cartridge. A logarithmic dilution series corresponding to this Z may be fully automatically produced without any risk of a manual pipetting error. In this manner, a cartridge may be configured for any Z that may be used.
In embodiments of the invention, a more generally configured cartridge may optionally enable production of several different logarithmic dilution series. By way of example, different inlets may be used, to this end, for the solution A, said inlets being labeled with the respective dilution factor Z. The respective inlet will portion the solution to be diluted such that the corresponding dilution factor Z is implemented. Depending on the dilution series desired, the sample is then filled into the corresponding inlet in excess, the sample is portioned to an adequate volume at the corresponding inlet, and it is subsequently passed on to the first dilution stage (mixing chamber). In this manner, the dilution series most widely used in laboratory routine, such as Z=2, Z=\sqrt{10}, Z=3, Z=\sqrt{10}, Z=4, Z=5, Z=10, etc., may thus be produced with a single cartridge. The user may then fill up the corresponding inlet as needed.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A device for producing a dilution series from a solution to be diluted, which comprises a substance to be diluted, and a dilution solution, comprising:
a body of rotation comprising fluidic structures, a drive configured to subject the body of rotation to rotations of different rotation protocols, and
a controller configured to control the drive so as to pass through the rotation protocols, the fluidic structures comprising:
a first mixing chamber comprising at least one fluid outlet,
a second mixing chamber comprising at least one fluid inlet,
a fluidic connection between the fluid outlet of the first mixing chamber and the fluid inlet of the second mixing chamber,
the fluidic connection between the first mixing chamber and the second mixing chamber being configured such that, when passing through a first rotation protocol, a defined volume of the solution to be diluted and a defined volume of the dilution solution are mixed in the first mixing chamber so as to produce a first mixture comprising a first dilution ratio, no portion of the first mixture getting into the second mixing chamber, and
the fluidic connection between the first mixing chamber and the second mixing chamber being configured such that, when passing through a second rotation protocol, a defined partial volume of the first mixture is transported from the first mixing chamber through the fluidic connection into the second mixing chamber which has a defined volume of the dilution solution located therein, and such that a defined volume of the first mixture remains in the first mixing chamber,
the controller being configured to control the drive to pass through the first and second rotation protocols and to pass through a third rotation protocol after having passed through the first rotation protocol and the second rotation protocol, so as to mix, in the second mixing chamber, the defined partial volume of the first mixture with the defined volume of the dilution solution to produce a second mixture comprising a second dilution ratio.

2. The device as claimed in claim 1, wherein the third rotation protocol is the same as the first rotation protocol.

3. The device as claimed in claim 1, wherein the fluidic connection comprises a siphon, the siphon comprising a fluid inlet leading into the first mixing chamber at a first radial position, and a fluid outlet leading into the second mixing chamber at a second radial position, the second radial position being located radially outward of the first radial position.

4. The device as claimed in claim 1, wherein the fluidic structures comprise a third mixing chamber, the second mixing chamber comprising a fluid outlet connected to a fluid inlet of the third mixing chamber via a corresponding fluidic connection, the controller being configured to control the drive so as to once again pass through the second rotation protocol once the second mixture has been produced, so that a defined partial volume of the second mixture is transported from the second mixing chamber into the third mixing chamber which comprises a defined volume of the dilution solution located therein, and such that a defined volume of the second mixture remains in the second mixing chamber, and so as to pass through a further rotation protocol to mix the defined partial volume of the second mixture with the defined volume of the dilution solution in the third mixing chamber to produce a third mixture comprising a third dilution ratio.

5. The device as claimed in claim 1, wherein the fluidic structures comprise a number of n mixing chambers, one fluid outlet of a preceding mixing chamber being connected to one fluid inlet of a subsequent mixing chamber via a corresponding fluidic connection, respectively, the controller being configured to pass through corresponding rotation protocols so as to produce n mixtures comprising n different dilution ratios, n being an integer larger than or equal to three, in the n mixing chambers.

6. The device as claimed in claim 5, wherein the defined volume of the solution to be diluted, the defined volumes of the dilution solution, and the defined partial volumes of the respective mixtures are configured such that the n mixtures represent a logarithmic dilution series.

7. The device as claimed in claim 6, wherein a preceding mixing chamber is arranged radially further inward within the body of rotation than a subsequent mixing chamber.

8. The device as claimed in claim 6, wherein the fluidic structures comprise a waste chamber, a fluid outlet of the n^{th} mixing chamber being fluidically connected to a fluid inlet of the waste chamber via a corresponding fluidic connection, the controller being configured to control the drive to pass through the second rotation protocol once the n^{th} mixture has been produced in the n^{th} mixing chamber, so that a defined partial volume of the n^{th} mixture is transported from the n^{th} mixing chamber into the waste chamber, and so that a defined volume of the n^{th} mixture remains in the n^{th} mixing chamber.

9. The device as claimed in claim 1, wherein the fluidic structures comprise a plurality of dosing chambers, whose number corresponds to the number of mixing chambers, each of the dosing chambers being configured to provide a defined volume of the dilution solution, each of the dosing chambers being connected to one of the mixing chambers via a fluidic valve.

10. The device as claimed in claim 9, wherein the fluidic valve is configured to allow the dilution solution to pass upon rotation of the body of rotation in accordance with a fourth rotation protocol and to not allow it to pass upon a rotation of the body of rotation in accordance with a fifth rotation protocol.

11. The device as claimed in claim 10, wherein the fluidic valve comprises a hydrophobic bottleneck which the dilution solution may pass.

12. The device as claimed in claim 9, wherein the fluidic structures comprise a common fluid channel, via which the dosing chambers may be filled with the defined volumes of the dilution solution.

13. The device as claimed in claim 12, wherein the controller is configured to control the drive to subject the body of rotation to a rotational frequency at which the dosing chambers are filled with the defined volumes of the dilution solution while the fluidic valves are closed, and to subsequently increase the rotational frequency such that the valves will allow the defined volumes of the dilution solution to pass into the mixing chambers.

14. The device as claimed in claim 1, wherein the first rotation protocol and the third rotation protocol comprise varying the rotational frequency several times.

15. The device as claimed in claim 2, wherein the second rotation protocol comprises reducing the rotational frequency to below a rotational-frequency threshold at which a capillary force in the siphon predominates over a centrifugal force caused by the rotation, so that the siphon will fill up in a capillary manner, and comprises subsequently increasing the rotational frequency to above a rotational frequency at which a meniscus at the fluid outlet of the siphon is overcome.

16. The device as claimed in claim 1, wherein the fluidic structures comprise a pre-portioning chamber for the substance to be diluted which is fluidically connected to the first mixing chamber and is configured to pass on a defined volume of the solution to be diluted to the first mixing chamber, which volume is independent of a filled-in volume of the solution to be diluted, provided that a larger volume of the solution to be diluted than the defined volume is filled into the pre-portioning chamber.

17. The device as claimed in claim 16, comprising a plurality of corresponding pre-portioning chambers comprising separate inlets configured to pass on different defined volumes of the solution to be diluted to the first mixing chamber so that dilution series comprising different dilution ratios may be produced, it being possible for one of the dilution series to be selected by choosing one of the inlets.

18. The device as claimed in claim 17, wherein the pre-portioning chamber is configured in an insert of the body of rotation, so that different dilution series may be implemented by switching between inserts comprising pre-portioning chambers configured to pass on different defined volumes.

19. The device as claimed in claim 1, wherein at least one of the mixing chambers comprises a fluid output via which the mixture produced in the mixing chamber may be centrifugally transported into a chamber located radially further outward in the body of rotation, or into a receptacle which is detachable from the body of rotation.

20. A fluidic module for a device for producing a dilution series from a solution to be diluted, which comprises a substance to be diluted, and a dilution solution, said device comprising:
a body of rotation comprising fluidic structures,
a drive configured to subject the body of rotation to rotations of different rotation protocols, and
a controller configured to control the drive so as to pass through the rotation protocols,
the fluidic structures comprising:
a first mixing chamber comprising at least one fluid outlet,
a second mixing chamber comprising at least one fluid inlet,
a fluidic connection between the fluid outlet of the first mixing chamber and the fluid inlet of the second mixing chamber,
the fluidic connection between the first mixing chamber and the second mixing chamber being configured such that, when passing through a first rotation protocol, a defined volume of the solution to be diluted and a defined volume of the dilution solution are mixed in the first mixing chamber so as to produce a first mixture comprising a first dilution ratio, no portion of the first mixture getting into the second mixing chamber, and
the fluidic connection between the first mixing chamber and the second mixing chamber being configured such that, when passing through a second rotation protocol, a defined partial volume of the first mixture is transported from the first mixing chamber through the fluidic connection into the second mixing chamber which has a defined volume of the dilution solution located therein, and such that a defined volume of the first mixture remains in the first mixing chamber,
the controller being configured to control the drive to pass through the first and second rotation protocols and to pass through a third rotation protocol after having passed through the first rotation protocol and the second rotation protocol, so as to mix, in the second mixing chamber, the defined partial volume of the first mixture with the defined volume of the dilution solution to produce a second mixture comprising a second dilution ratio,
which fluidic module forms the body of rotation or forms the body of rotation when inserted into a carrier, which comprises the fluidic structures which comprise the first mixing chamber comprising the at least one fluid outlet, the second mixing chamber comprising the at least one fluid inlet, and the fluidic connection between the fluid outlet of the first mixing chamber and the fluid inlet of the second mixing chamber.

21. The fluidic module as claimed in claim 20, wherein the fluidic connection comprises the siphon, the siphon comprising the fluid inlet leading into the first mixing chamber at the first radial position, and the fluid outlet leading into the second mixing chamber at the second radial position, the second radial position being located radially outward of the first radial position.

22. The fluidic module as claimed in claim 20, wherein the fluidic structures comprise the number of m mixing chambers, one fluid outlet of a preceding mixing chamber being connected to one fluid inlet of a subsequent mixing chamber via a corresponding fluidic connection, respectively.

23. The fluidic module as claimed in claim 22, wherein a preceding mixing chamber is arranged radially further inward in the body of rotation than a subsequent mixing chamber.

24. The fluidic module as claimed in claim 20, wherein the fluidic structures comprise the plurality of dosing chambers, whose number corresponds to the number of mixing chambers, each of the dosing chambers being configured to provide a defined volume of the dilution solution, each of the dosing chambers being connected to one of the mixing chambers via a fluidic valve.

25. The fluidic module as claimed in claim 24, wherein the fluidic structures comprise the common fluid channel, via which the dosing chambers may be filled with the defined volumes of the dilution solution.

26. A method of producing a dilution series from a solution to be diluted, which comprises a substance to be diluted, and a dilution solution, comprising:
introducing a defined volume of the dilution solution into a first mixing chamber and introducing a defined volume of the dilution solution into a second mixing chamber, the first and the second mixing chamber being formed in a body of rotation, and a fluid outlet of the first mixing chamber being connected to a fluid inlet of the second mixing chamber via a fluidic connection;
introducing a defined volume of the solution to be diluted into the first mixing chamber;
subjecting the body of rotation to a first rotation protocol, so that a first mixture comprising a first dilution ratio is produced in the first mixing chamber without any portion of the first mixture getting into the second mixing chamber;
subjecting the body of rotation to a second rotation protocol, so that a defined partial volume of the first mixture is transported from the first mixing chamber into the second fluid chamber which comprises the defined volume of the dilution solution located therein, and so that a defined volume of the first mixture remains in the first mixing chamber; and
subjecting the body of rotation to a third rotation protocol so as to mix, in the second mixing chamber, the defined partial volume of the first mixture with the defined volume of the dilution solution to produce a second mixture comprising a second dilution ratio.

27. The method as claimed in claim 26, wherein the volume transferred from the first mixing chamber into the second mixing chamber is dependent on an added volume of the solution to be diluted and/or on the defined volume of the dilution solution.

28. The method as claimed in claim 26, wherein a body of rotation comprising n mixing chambers, one fluid outlet of a preceding mixing chamber being connected to one fluid inlet of a subsequent mixing chamber via a corresponding fluidic connection, respectively, is used, the method further comprising subjecting the body of rotation to corresponding rotation protocols so as to transport respective partial volumes of an n−1^{th} mixture into an n^{th} mixing chamber, a defined volume of the n−1^{th} mixture remaining in the n−1^{th} mixing chamber so as to produce a dilution series comprising n mixtures comprising n different dilution ratios, n being an integer larger than or equal to three.

29. The method as claimed in claim 28, wherein the n mixtures represent a logarithmic dilution series.

30. The method as claimed in claim 26, wherein at least one of the mixtures is processed further on the body of rotation once it has been produced, and/or is transported into a chamber located radially further outward on the body of rotation, or into a detachable receptacle.
